(19) United States
(12) Patent Application Publication
(10) Pub. No.: US 2021/0212021 A1
(43) Pub. Date: Jul. 8, 2021

(54) METHOD, COMMUNICATION DEVICE, AND NETWORK NODE FOR TRANSMITTING OR RECEIVING PAGING MESSAGE

(71) Applicant: LG Electronics Inc., Seoul (KR)

(72) Inventors: Myungjune YOUN, Seoul (KR); Laeyoung KIM, Seoul (KR); Hyunsook KIM, Seoul (KR)

(21) Appl. No.: 17/269,060

(22) PCT Filed: Aug. 16, 2019
(86) PCT No.: PCT/KR2019/010444

§ 371 Date: Feb. 17, 2021

(30) Foreign Application Priority Data
Aug. 17, 2018 (KR) 10-2018-0096107

(51) Int. Cl. H04W 68/02; H04W 68/00; H04W 76/16

(52) U.S. Cl. CPC H04W 68/02; H04W 76/16; H04W 68/005

(57) ABSTRACT

A disclosure of the present specification provides a method for transmitting a paging message to a communication device by a first network node. The method may comprise the steps of: receiving a second message relating to downlink data to be transmitted to the communication device, from a second network node; in a case where the second message is related to a first service and the communication device is in an idle state for 3GPP access, transmitting a paging message and a NAS notification message to the communication device; and receiving a service request message relating to the downlink data from the communication device through the 3GPP access.

### BACKGROUND OF THE DISCLOSURE

### Field of the Disclosure

The present disclosure generally relates to next-generation mobile communications.

### Related Art

With the success of Evolved Universal Terrestrial Radio Access Network (E-UTRAN) for the fourth-generation mobile communication which is Long Term Evolution (LTE)/LTE-Advanced (LTE-A), the next generation mobile communication, which is the fifth-generation (so called 5G) mobile communication, has been attracting attentions and more and more researches are being conducted.

For the fifth-generation (so called 5G) mobile communication, a new radio access technology (New RAT or NR) have been studied and researched.

The fifth-generation communication defined by the International Telecommunication Union (ITU) refers to providing a maximum data transmission speed of 20 Gbps and a maximum transmission speed of 100 Mbps per user in anywhere. It is officially called “IMT-2020” and aims to be released around the world in 2020.

The ITU suggests three usage scenarios, for example, enhanced Mobile BroadBand (eMBB), massive Machine Type Communication (mMTC), and Ultra Reliable and Low Latency Communications (URLLC).

URLLC relates to a usage scenario in which high reliability and low delay time are required. For example, services like autonomous driving, automation, and virtual realities requires high reliability and low delay time (e.g., 1 ms or less). A delay time of the current 4G (LTE) is statistically 21-43 ms (best 10%), 33-75 ms (median). Thus, the current 4G (LTE) is not sufficient to support a service requiring a delay time of 1 ms or less.

If a terminal ((wireless) communication device including a user equipment (UE)) is idle state in 3GPP access, when DL (downlink) data to be transmitted to the terminal arrives, an access and mobility management function (AMF) should perform a paging procedure. That is, the AMF needs to transmit a paging message to the terminal.

Here, the UE performs an operation of periodically checking the paging message transmitted from the AMF at a specific time by performing a discontinuous reception (DRX) operation. When the terminal, upon reading (receiving) the paging message, recognizes that the paging message is a paging message for itself, the terminal performs a service request (SR) procedure in response to the paging message.

In this process, the response of the terminal to the paging message (i.e., performing the SR procedure) may be delayed according to a setting of a DRX cycle. If the terminal cannot receive the paging message due to poor communication conditions such as a radio condition or the like, the AMF may retransmit the paging message to the terminal according to an operator policy. When the AMF retransmits the paging message to the terminal, a time may be further delayed until the terminal performs the SR procedure.

In a 5G NR, in a case where the terminal is provided with a low latency service (e.g., a URLLC-related service), a delay caused by the terminal not receiving a paging message or the AMF retransmitting the paging message may affect end-to-end services. Due to the delay time, a problem that the terminal may not be provided with the low latency service may arise. Accordingly, there is a need for a method for reducing a delay time so that the terminal may quickly receive the low latency service.

### SUMMARY

Accordingly, a disclosure of the present disclosure has been made in an effort to solve the aforementioned problem.

In an aspect, a method for transmitting a paging message to a communication device, the method performed by a first network node is provided. The method includes: receiving a second message related to downlink data to be transmitted to the communication device from a second network node; transmitting a paging message and a non-access stratum (NAS) notification message to the communication device when the second message is related to a first service and the communication device is in Idle state for 3^{rd} generation partnership project (3GPP) access, wherein the paging message is transmitted to the communication device through the 3GPP access and the NAS notification is transmitted to the communication device through non-3GPP access; and receiving a service request message for the downlink data from the communication device through the 3GPP access.

The communication device may be in an Idle state for the 3GPP access and may be in a connected state for the non-3GPP access.

The method may further include determining whether the second message is related to the first service.

The second message may include an allocation and retention priority (ARP) value, and whether the second message is related to the first service may be determined based on the ARP value included in the second message.

The second message may further include first information informing that the second message is related to the first service, and whether the second message is related to the first service may be determined based on the first information included in the second message.

Whether the second message is related to the first service may be determined based on second information stored in the first network node.

The second information may include at least one of a PDU session ID related to the first service, a data network name (DNN) related to the first service, single-network slice selection assistance information (S-NSSAI) related to the first service, or UE capability information related to the first service.

The second message may include a PDU session ID related to the downlink data, and whether the second message is related to the first service may be determined based on the PDU session ID included in the second message and the second information.

The first network node may be an access and mobility management function (AMF), and the second network node may be a session management function (SMF).

In another aspect, a method for transmitting a service request message is provided. The method includes: receiving a first message including information indicating that a UE accepts establishment of a PDU session associated with a first service from a second network node; receiving at least one of a paging message for downlink data or a non-access stratum (NAS) notification message related to the downlink data, wherein the downlink data is associated with the first service, and wherein the paging message is transmitted to the communication device through 3^{rd} generation partnership project (3GPP) access, and the NAS notification message is transmitted to the communication device through non-3GPP access; and transmitting a service request message for the downlink data, wherein the communication device may be in an idle state for the 3GPP access and in a connected state for the non-3GPP access.

The service request message may be transmitted through the 3GPP access.

The method may further include handing over the PDU session associated with the first service from the 3GPP access to the non-3GPP access when transmission of the service request message through the 3GPP access fails.

The communication device may be an autonomous driving device that communicates with at least one of a mobile terminal, a network, and an autonomous vehicle other than the communication device.

In another aspect, a processor of a first network node is provided. The processor, which controls the first network node, may be configured to: receive a second message related to downlink data to be transmitted from the second network node to the communication device, transmit a paging message and a non-access stratum (NAS) notification message to the communication device when the second message is related to a first service and the communication device is Idle state for 3^{rd} generation partnership project (3GPP) access, wherein the paging message is transmitted to the communication device through the 3GPP access and the NAS notification is transmitted to the communication device through non-3GPP access; and receive a service request message for the downlink data from the communication device through the 3GPP access.

### Advantageous Effects

According to the present disclosure, the problem of the related art described above may be solved.

### BRIEF DESCRIPTION OF THE DRAWINGS

FIG. 1 is a structural diagram of a next-generation mobile communication network.

FIG. 2 is an exemplary diagram illustrating a predicted structure of a next generation mobile communication in terms of a node.

FIG. 3 is an exemplary diagram illustrating an architecture for supporting a concurrent access through two data networks.

FIG. 4 is another exemplary diagram showing a structure of a radio interface protocol between a UE and a gNB.

FIG. 5A is an exemplary diagram showing an example of an architecture for implementing the concept of network slicing.

FIG. 5B is an exemplary diagram showing another example of an architecture for implementing the concept of network slicing.

FIG. 6a is an exemplary diagram illustrating an architecture to which a local breakout (LBO) scheme is applied during roaming and FIG. 6b is an exemplary diagram illustrating an architecture to which a home routed (HR) scheme is applied during roaming.

FIGS. 7a to 7f illustrate architectures for detouring data to a non-3GPP network.

FIG. 8 is an exemplary diagram showing a state of a PDU session.

FIGS. 9a and 9b is a signal flow chart showing an exemplary registration procedure.

FIG. 10A is a signal flowchart illustrating an exemplary PDU session establishment procedure. FIG. 10B is a signal flowchart illustrating an exemplary PDU session establishment procedure continued from FIG. 10A.

FIGS. 11A to 11C are signal flowcharts illustrating an exemplary UE initiated service request procedure.

FIG. 12 is a signal flowchart illustrating an exemplary network initiated service request procedure.

FIG. 13 is a signal flowchart illustrating an example of a scheme according to the present disclosure.

FIG. 14 is a signal flowchart illustrating an example of an operation of a network node according to the present disclosure.

FIG. 15 is a signal flowchart illustrating an example of an operation of a communication device according to the present disclosure.

FIG. 16 shows a wireless communication device according to the present disclosure.

FIG. 17 is a detailed block diagram of a transmission/reception unit of a wireless communication device of FIG. 16.

FIG. 18 is a detailed block diagram of the wireless communication device of FIG. 16.

FIG. 19 illustrates an example of 5G use scenarios.

FIG. 20 illustrates an AI system according to an embodiment.

### DESCRIPTION OF EXEMPLARY EMBODIMENTS

The technical terms used herein are used to merely describe specific embodiments and should not be construed as limiting the present disclosure. Further, the technical terms used herein should be, unless defined otherwise, interpreted as having meanings generally understood by those skilled in the art but not too broadly or too narrowly. Further, the technical terms used herein, which are determined not to exactly represent the spirit of the disclosure, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present disclosure includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present disclosure, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present disclosure.

It will be understood that when an element or layer is referred to as being “connected to” or “coupled to” another element or layer, it may be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present disclosure will be described in greater detail with reference to the accompanying drawings. In describing the present disclosure, for ease of understanding, the same reference numerals are used to denote the same components throughout the drawings, and repetitive description on the same components will be omitted. Detailed description on well-known arts which are determined to make the gist of the disclosure unclear will be omitted. The accompanying drawings are provided to merely make the spirit of the disclosure readily understood, but not should be intended to be limiting of the disclosure. It should be understood that the spirit of the disclosure may be expanded to its modifications, replacements or equivalents in addition to what is shown in the drawings.

In the accompanying drawings, a user equipment (UE) is illustrated by way of example, but the illustrated UE may also be referred to in terms of UE 100 (terminal), mobile equipment (ME), and the like. In addition, the UE may be a portable device such as a notebook computer, a mobile phone, a PDA, a smartphone, or a multimedia device or may be a non-portable device such as a PC or vehicle-mounted device.

The present disclosure is described based on universal mobile telecommunication system (UMTS), evolved packet core (EPC), and next-generation (so-called 5G) mobile communication networks, but the present disclosure is not limited to these communication systems and may also be applied to all communication systems and methods to which the technical idea of the present disclosure may be applied.

### Definition of Terms

Before describing the present disclosure with reference to the accompanying drawings, terms used in the present disclosure will be briefly defined in order to help understanding of the present disclosure.

UE/MS: User equipment/mobile station, which refers to a UE 100 device.

EPS: An acronym for evolved packet system, which refers to a core network supporting a long term evolution (LTE) network. Network in the form of evolved UMTS

PDN (public data network): An independent network in which a server providing services is located

PDN-GW (packet data network gateway): A network node of an EPS network that performs functions of UE IP address allocation, packet screening & filtering, and charging data collection.

Serving GW (serving gateway): A network node of the EPS network that performs mobility anchor, packet routing, idle mode packet buffering, and triggering MME to page UE functions

eNodeB: Abase station of an EPS installed outdoors, and a cell coverage scale corresponds to a macro cell.

MME: An acronym for mobility management entity and serves to control each entity within the EPS to provide session and mobility for a UE.

Session: A session is a path for data transmission, and its unit may be a PDN, a bearer, an IP flow unit, etc. Each unit may be classified into an entire target network unit (APN or PDN unit) as defined in 3GPP, a unit classified by QoS (bearer unit) therein, and a destination IP address unit.

APN: An acronym for access point name, which is provided to a UE as the name of an access point managed by a network. In other words, it is a character string that refers to or identifies a PDN. In order to access a requested service or network (PDN), the requested service or the network is accessed through a corresponding P-GW, and the APN is a name (character string) predefined in the network so that this P-GW may be found. For example, the APN may be in the form of internet.mnc012.mcc345.gprs.

PDN connection: It indicates a connection from the UE to the PDN, that is, an association (connection) between the UE expressed by an ip address and the PDN expressed by the APN. This refers to a connection between entities (UE 100-PDN GW) in a core network so that a session may be formed.

UE Context: Context information of the UE used to manage the UE in the network, that is, context information including a UE id, mobility (current location, etc.), and session properties (QoS, priority, etc.)

NAS (non-access-stratum): An upper stratum of a control plane (control plane) between the UE and an MME. It supports mobility management between the UE and the network, session management, and IP address maintenance

PLMN: An abbreviation for public land mobile network, which refers to the operator's network identification number. In a roaming situation of the UE, PLMN is classified into a home PLMN (HPLMN) and a visited PLMN (VPLMN).

DNN: An acronym for data network name. It is provided to the UE as the name of an access point managed by the network, similar to the APN. In 5G systems, DNN is used equivalent to APN.

The contents described later in this disclosure may be applied to a next-generation (so-called 5^{th} generation or 5G) mobile communication network.

<Structure of Next-Generation Mobile Communication System>

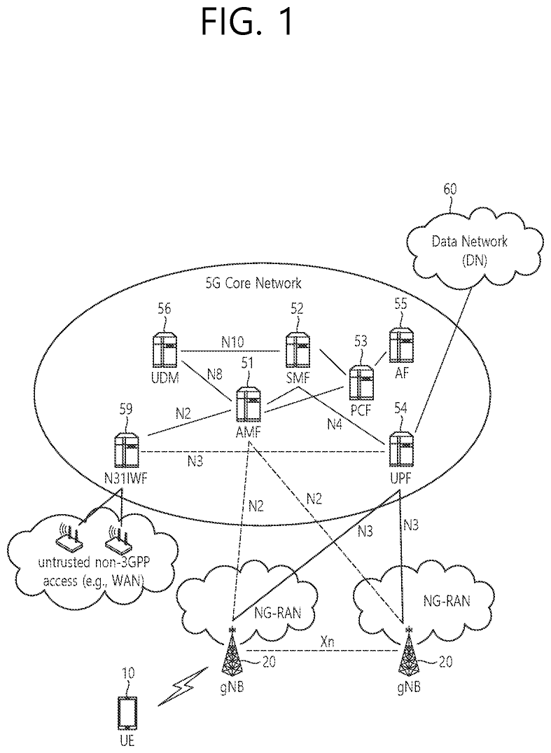

FIG. 1 is a structural diagram of a next-generation mobile communication network.

The next-generation mobile communication network (5G system) may include various components, part of which are shown in FIG. 1, including an access and mobility management function (AMF) 51, a session management function (SMF) 52, a policy control function (PCF) 53, an application function (AF) 55, a non-3GPP interworking function (N3IWF) 59, a user plane function (UPF) 54, and a unified data management (UDM) data network 56.

A UE 10 is connected to a data network 60 via the UPF 54 through a Next Generation Radio Access Network (NG-RAN) including the gNB 20.

The UE 10 may be provided with a data service even through untrusted non-3GPP access, e.g., a wireless local area network (WLAN). In order to connect the non-3GPP access to a core network, the N3IWF 59 may be deployed.

The illustrated N3IWF 59 performs a function of managing interworking between the non-3GPP access and the 5G system. When the UE 10 is connected to non-3GPP access (e.g., WiFi referred to as IEEE 801.11), the UE 10 may be connected to the 5G system through the N3IWF 59. The N3IWF performs control signaling with the AMF and is connected to the UPF through an N3 interface for data transmission.

The illustrated AMF 51 may manage access and mobility in the 5G system. The AMF 51 may perform a function of managing NAS security. The AMF 51 may perform a function of handling mobility in an idle state.

The illustrated UPF 54 is a type of gateway through which user data is transmitted/received. The UPF 54 may perform the entirety or a portion of a user plane function of a serving gateway (S-GW) and a packet data network gateway (P-GW) of 4G mobile communication.

The UPF 54 operates as a boundary point between a next generation radio access network (NG-RAN) and the core network and maintains a data path between the gNB 20 and the SMF 52. In addition, when the UE 10 moves over an area served by the gNB 20, the UPF 54 serves as a mobility anchor point. The UPF 54 may perform a function of handling a PDU. For mobility within the NG-RAN (which is defined after 3GPP Release-15), the UPF 54 may route packets. In addition, the UPF 54 may also serve as an anchor point for mobility with another 3GPP network (RAN defined before 3GPP Release-15, e.g., universal mobile telecommunications system (UMTS) terrestrial radio access network (UTRAN), evolved (E)-UTRAN or global system for mobile communication (GERAN)/enhanced data rates for global evolution (EDGE) RAN. The UPF 54 may correspond to a termination point of a data interface toward the data network.

The illustrated PCF 53 is a node that controls an operator's policy.

The illustrated AF 55 is a server for providing various services to the UE 10.

The illustrated UDM 56 is a kind of server that manages subscriber information, such as home subscriber server (HSS) of 4G mobile communication. The UDM 56 stores and manages the subscriber information in a unified data repository (UDR).

The illustrated SMF 52 may perform a function of allocating an Internet protocol (IP) address of the UE. In addition, the SMF may control a protocol data unit (PDU) session.

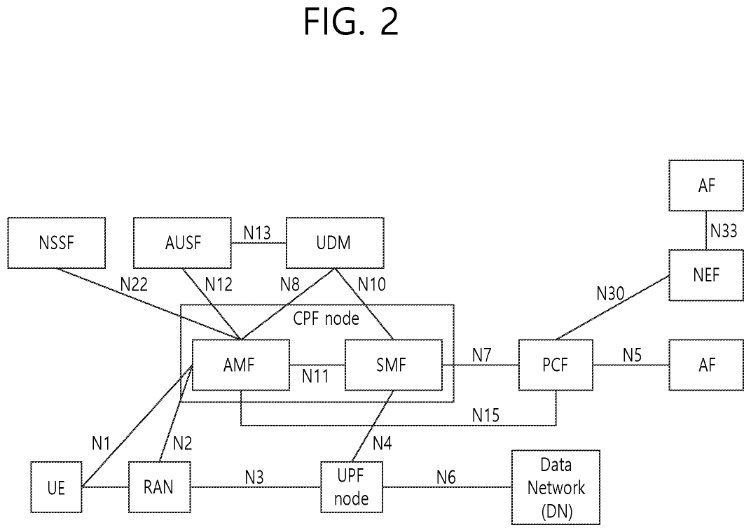

FIG. 2 is an exemplary diagram illustrating a predicted structure of a next generation mobile communication in terms of a node.

Referring to FIG. 2, the UE is connected to a data network (DN) through a next generation RAN (Radio Access Network).

The Control Plane Function (CPF) node shown in FIG. 2 may perform all or part of the Mobility Management Entity (MME) function of the fourth generation mobile communication, and all or a part of the control plane function of the Serving Gateway (S-GW) and the PDN-gateway (P-GW) of the fourth generation mobile communication. The CPF node includes an Access and Mobility Management Function (AMF) node and a Session Management Function (SMF) node.

The user plane function (UPF) node shown in the drawing is a type of a gateway over which user data is transmitted and received. The UPF node may perform all or part of the user plane functions of the S-GW and the P-GW of the fourth generation mobile communication.

The Policy Control Function (PCF) node shown in FIG. 2 is configured to control a policy of the service provider.

The illustrated Application Function (AF) node refers to a server for providing various services to the UE.

The Unified Data Management (UDM) node as shown refers to a type of a server that manages subscriber information, such as a Home Subscriber Server (HSS) of 4th generation mobile communication. The UDM node stores and manages the subscriber information in the Unified Data Repository (UDR).

The Authentication Server Function (AUSF) node as shown authenticates and manages the UE.

The Network Slice Selection Function (NSSF) node as shown refers to a node for performing network slicing as described below.

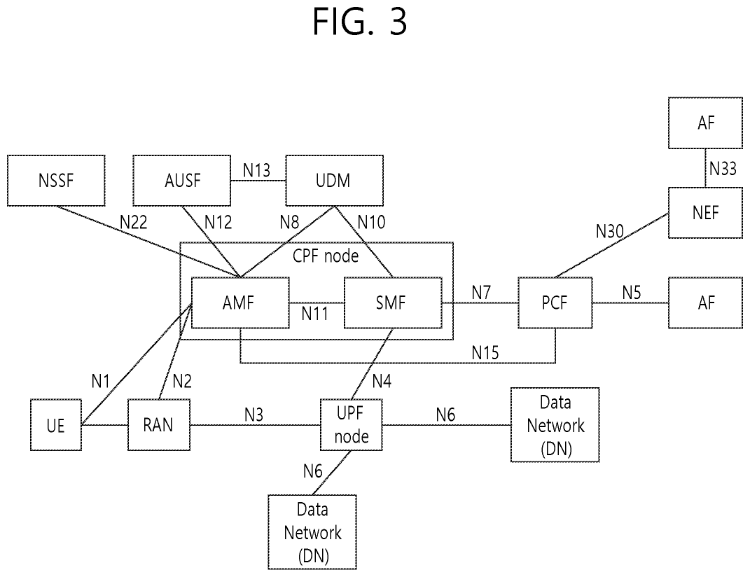

In FIG. 3, the UE may simultaneously access two data networks using multiple PDU sessions.

FIG. 3 illustrates an architecture that allows the UE to simultaneously access two data networks using one PDU session.

FIG. 3 illustrates an architecture that allows the UE to simultaneously access two data networks using one PDU session.

For reference, descriptions of the reference points shown in FIGS. 1 to 3 are as follows.

N1: Reference point between UE and AMF

N2: Reference point between NG-RAN and AMF

N3: Reference point between NG-RAN and UPF

N4: Reference point between SMF and UPF

N5: Reference point between PCF and AF

N6: Reference point between UPF and DN

N7: Reference point between SMF and PCF

N8: Reference point between UDM and AMF

N10: Reference point between UDM and SMF

N11: Reference point between AMF and SMF

N12: Reference point between AMF and AUSF

N13: Reference point between UDM and AUSF

N15: Reference point between PCF and AMF in a non-roaming scenario and reference point between AMF and PCF of visited network in roaming scenario

N22: Reference point between AMF and NSSF

N30: Reference point between PCF and NEF

N33: Reference point between AF and NEF

In FIGS. 2 and 3, AF by a third party other than an operator may be connected to 5GC through a network exposure function (NEF).

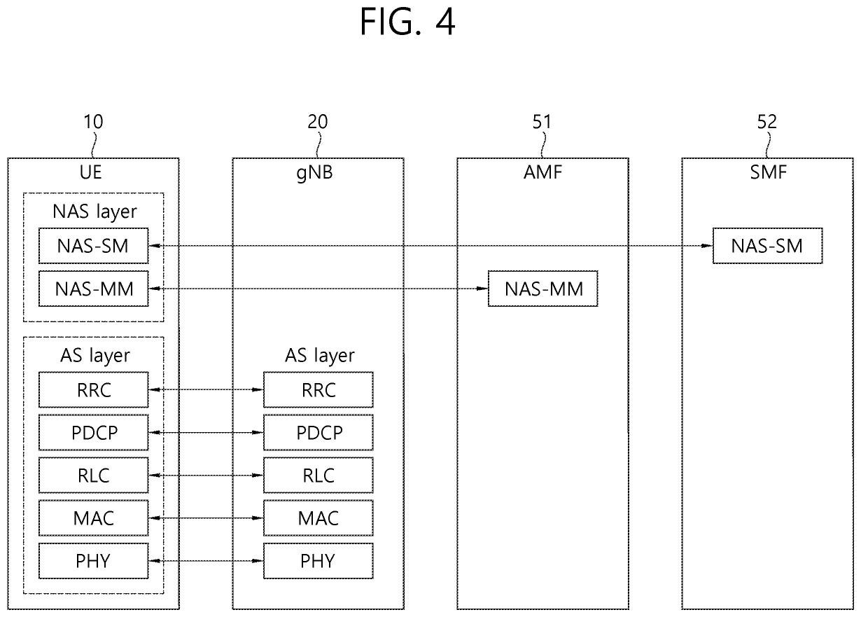

FIG. 4 is another exemplary diagram showing a structure of a radio interface protocol between a UE and a gNB.

The radio interface protocol is based on the 3GPP radio access network standard. The radio interface protocol is horizontally composed of a physical layer, a data link layer, and a network layer, and is vertically divided into a user plane for transmission of data information and a control plane for transfer of control signal (signaling).

The protocol layers may be divided into L1 (first layer), L2 (second layer), and L3 layer (third layer) based on the lower three layers of the open system interconnection (OSI) reference model widely known in communication systems.

Hereinafter, each layer of the radio protocol will be described.

The first layer, the physical layer, provides an information transfer service using a physical channel. The physical layer is connected to an upper medium access control layer through a transport channel, and data between the medium access control layer and the physical layer is transmitted through the transport channel. In addition, data is transmitted between different physical layers, that is, between the physical layers of a transmitting side and a receiving side through a physical channel.

The second layer includes a medium access control (MAC) layer, a radio link control (RLC) layer, and a packet data convergence protocol (PDCP) layer.

The third layer includes radio resource control (hereinafter abbreviated as RRC). The RRC layer is defined only in the control plane and is in charge of control of logical channels, transport channels, and physical channels related to configuration, reconfiguration and release of radio bearers. In this case, RB refers to a service provided by the second layer for data transfer between the UE and the E-UTRAN.

The NAS layer performs functions such as connection management (session management) and mobility management.

The NAS layer is divided into a NAS entity for mobility management (MM) and a NAS entity for session management (SM).

1) NAS entity for MM provides the following functions in general.

NAS procedures related to AMF include the following.
Registration management and access management procedures. AMF supports the following functions.
Secure NAS signal connection between UE and AMF (integrity protection, encryption)

2) The NAS entity for SM performs session management between the UE and the SMF.

The SM signaling message is processed, that is, generated and processed, at an NAS-SM layer of the UE and SMF. The contents of the SM signaling message are not interpreted by the AMF.
In the case of SM signaling transmission,
The NAS entity for the MM creates a NAS-MM message that derives how and where to deliver an SM signaling message through a security header representing the NAS transmission of SM signaling and additional information on a received NAS-MM.
Upon receiving SM signaling, the NAS entity for the SM performs an integrity check of the NAS-MM message, analyzes additional information, and derives a method and place to derive the SM signaling message.

Meanwhile, in FIG. 4, the RRC layer, the RLC layer, the MAC layer, and the PHY layer located below the NAS layer are collectively referred to as an access stratum (AS).

<Network Slice>

The following describes the slicing of the network to be introduced in the next generation mobile communication.

Next-generation mobile communication introduces the concept of network slicing in order to provide various services through a single network. In this connection, slicing a network refers to a combination of network nodes with the functions needed to provide a specific service. The network node that constitutes the slice instance may be a hardware independent node, or it may be a logically independent node.

Each slice instance may consist of a combination of all the nodes needed to construct the entire network. In this case, one slice instance alone may provide service to the UE.

Alternatively, the slice instance may consist of a combination of some of the nodes that make up the network. In this case, the slice instance may provide service to the UE in relation with other existing network nodes without the slice instance alone providing the service to the UE. In addition, a plurality of slice instances may cooperate with each other to provide the service to the UE.

The slice instance may differ from a dedicated core network in that all network nodes, including the core network (CN) node and the RAN may be separated from each other. Further, the slice instance differs from the dedicated core network in that the network nodes may be logically separated.

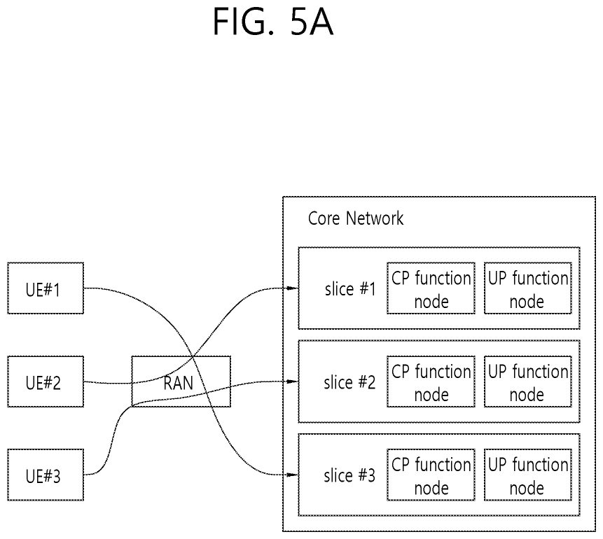

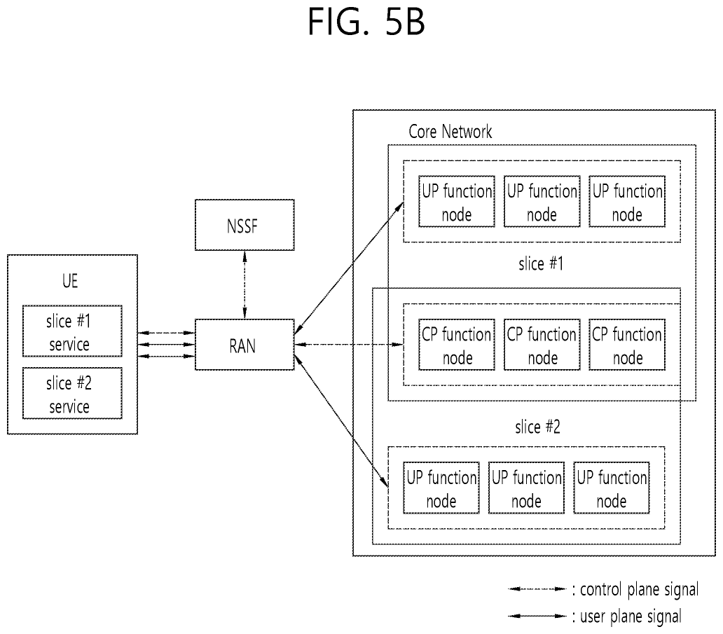

FIG. 5A is an exemplary diagram showing an example of an architecture for implementing the concept of network slicing.

As can be seen with reference to FIG. 5A, the core network CN may be divided into several slice instances. Each slice instance may include one or more of a CP function node and a UP function node.

Each UE may use a network slice instance suitable for its service through the RAN.

Unlike the case of FIG. 5A, each slice instance may share one or more of a CP function node and a UP function node with another slice instance. This will be described with reference to FIG. 5B as follows.

FIG. 5B is an exemplary diagram showing another example of an architecture for implementing the concept of network slicing.

Referring to FIG. 5B, a plurality of UP function nodes are clustered, and similarly, a plurality of CP function nodes are also clustered.

Also, referring to FIG. 5B, slice instance #1 (or instance #1) in the core network includes a first cluster of an UP function node. In addition, the slice instance #1 shares a cluster of the CP function node with slice #2 (or instance #2). The slice instance #2 includes a second cluster of UP function nodes.

The illustrated NSSF selects a slice (or instance) that may accommodate a service of the UE.

The illustrated UE may use service #1 through slice instance #1 selected by the NSSF and may use service #2 through slice instance #2 selected by N.

<Roaming in Next Generation Mobile Communication Network>

Meanwhile, there are two schemes of processing a signaling request from the UE in a situation in which the UE roams to a visited network, e.g., a Visited Public Land Mobile Network (VPLMN). In a local break out (LBO) scheme which is a first scheme, the signaling request from the UE is processed in the visited network. According to a home routing (HR) scheme which is a second scheme, the visited network delivers the signaling request from the UE to a home network.

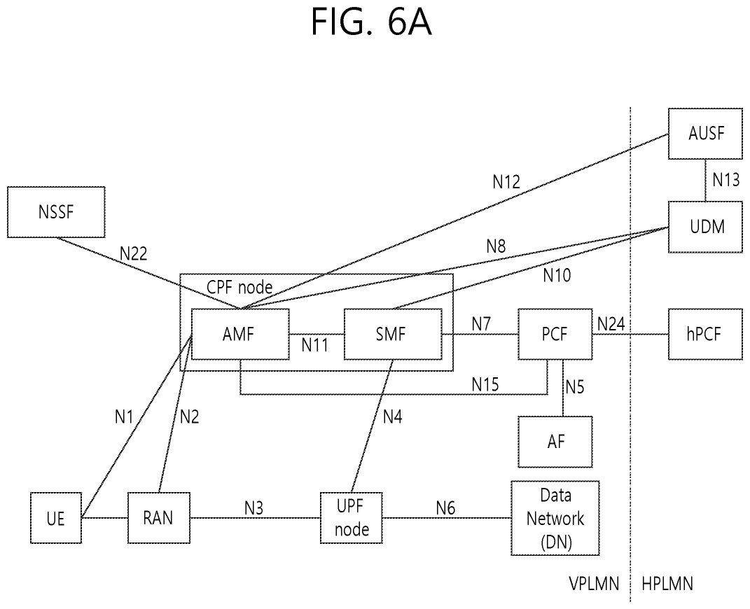

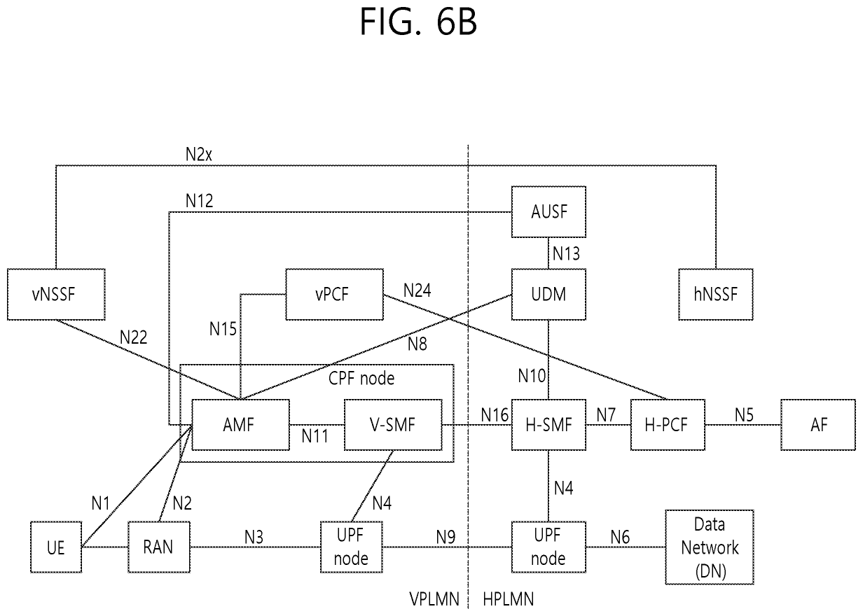

FIG. 6a is an exemplary diagram illustrating an architecture to which a local breakout (LBO) scheme is applied during roaming, and FIG. 6b is an exemplary diagram illustrating an architecture to which a home routed (HR) scheme is applied during roaming.

As illustrated in FIG. 6a, in an architecture to which the LBO scheme is applied, data of a user is delivered to a data network in the VPLMN. To this end, the PCF in the VPLMN performs an interaction with the AF in order to generate a PCC rule for a service in the VPLMN. A CPF node in the VPLMN generates the PCC rule based on a policy set internally according to a roaming agreement with a Home Public Land Mobile Network (HPLMN) operator.

As illustrated in FIG. 6b, in an architecture to which the HR scheme is applied, data of the UE is delivered to the data network in the HPLMN.

<Data Detouring to Non-3GPP Network>

In the next generation mobile communication, the data of the UE may be detoured to a non-3GPP network, e.g., a Wireless Local Area Network (WLAN) or WiFi.

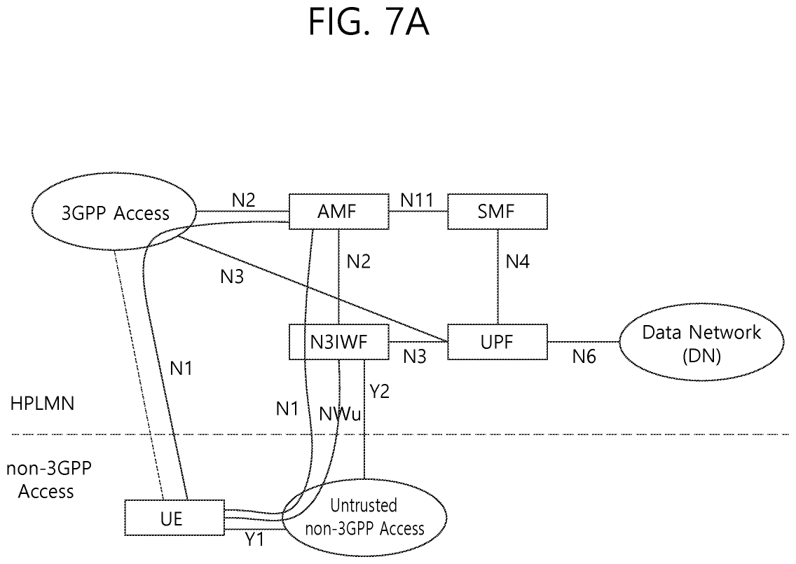

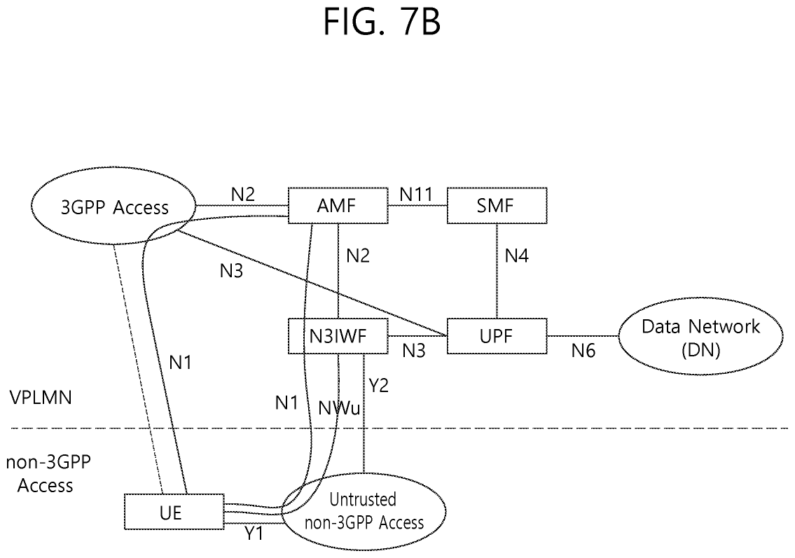

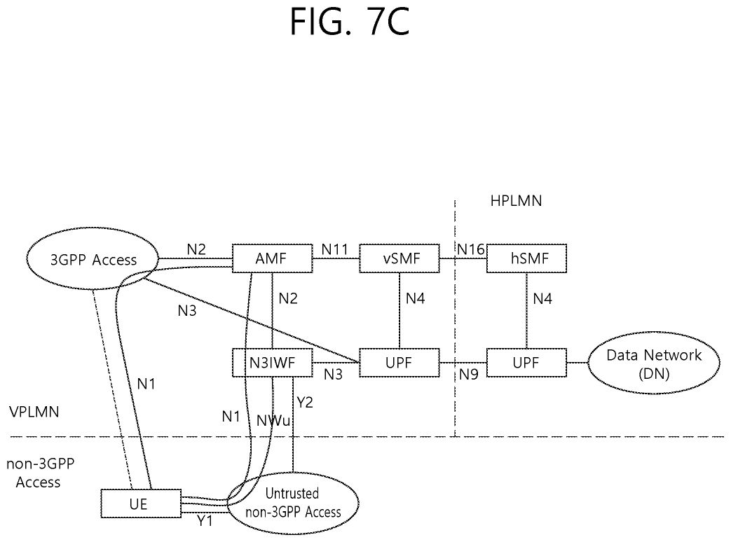

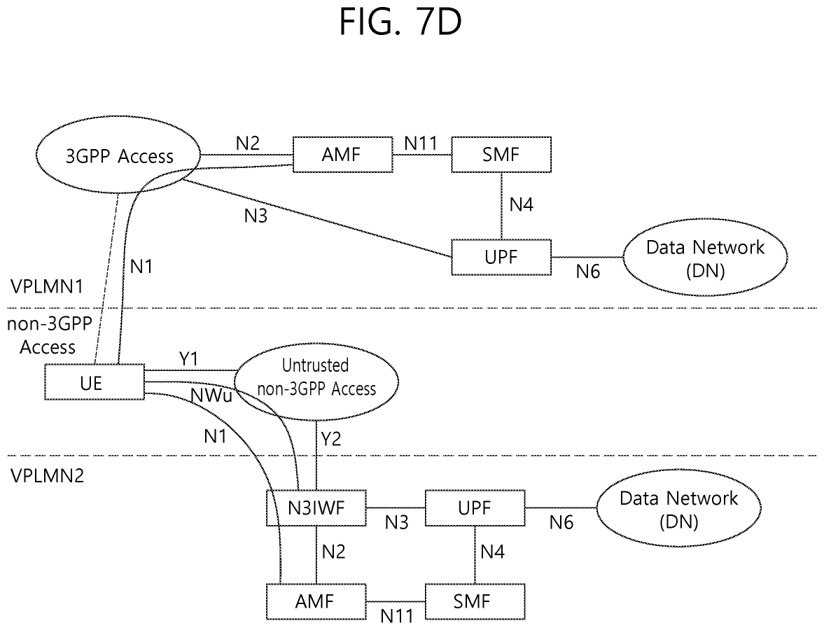

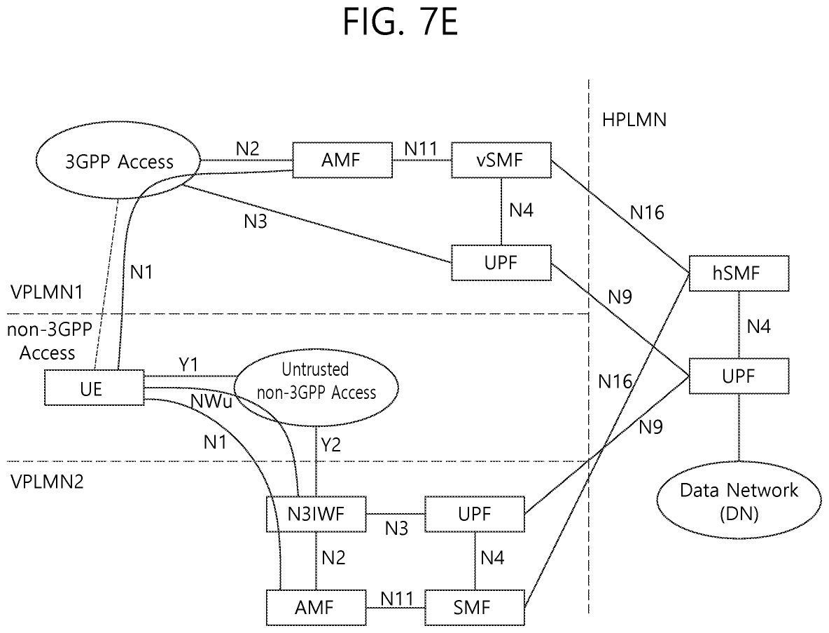

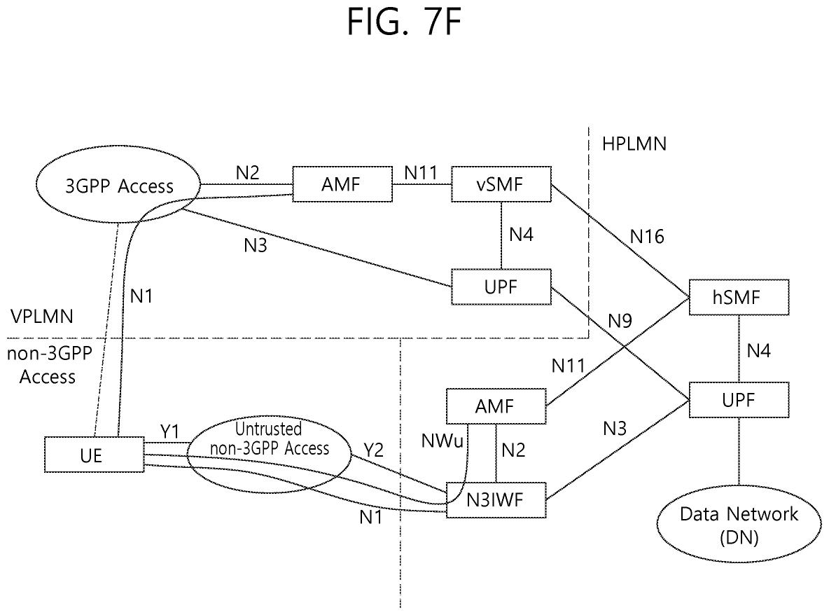

FIGS. 7a to 7f illustrate architectures for detouring data to a non-3GPP network.

The Wireless Local Area Network (WLAN) or Wi-Fi is considered as an untrusted non-GPP network. In order to connect the non-3GPP network to a core network, Non-3GPP InterWorking Function (N3IWF) may be added.

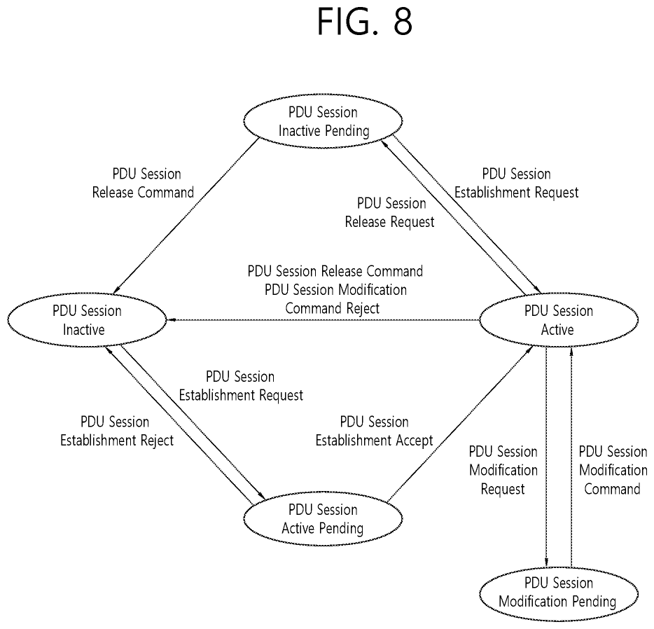

FIG. 8 is an exemplary diagram showing a state of a PDU session.

Referring to FIG. 8, a PDU session active state, a PDU session inactive state, a PDU session inactive pending state, a PDU session active pending state, and a PDU session modification pending state are shown.

The PDU session inactive state refers to a state in which no PDU session context exists.

The PDU session active pending state refers to a state in which the UE waits for a response from the network after initiating a PDU session establishment procedure to the network.

The PDU session active state means that the PDU session context is active in the UE.

The PDU session inactive pending state refers to a state in which the UE waits for a response from the network after performing a PDU session release procedure.

The PDU session modification pending state refers to a state in which the UE waits for a response from the network after performing the PDU session modification procedure.

<Registration Procedure>

In order to allow mobility tracking and data reception to be performed, and in order to receive a service, the UE needs to gain authorization. For this, the UE shall register to a network. The registration procedure is performed when the UE needs to perform initial registration to a 5G system. Additionally, the Registration Procedure is performed when the UE performs periodic registration update, when the UE relocates to a new tracking area (TA) in an Idle state, and when the UE needs to perform periodic registration renewal.

During the initial registration procedure, an ID of the UE may be obtained from the UE. The AMF may forward (or transfer) a PEI (IMEISV) to a UDM, SMF, and PCF.

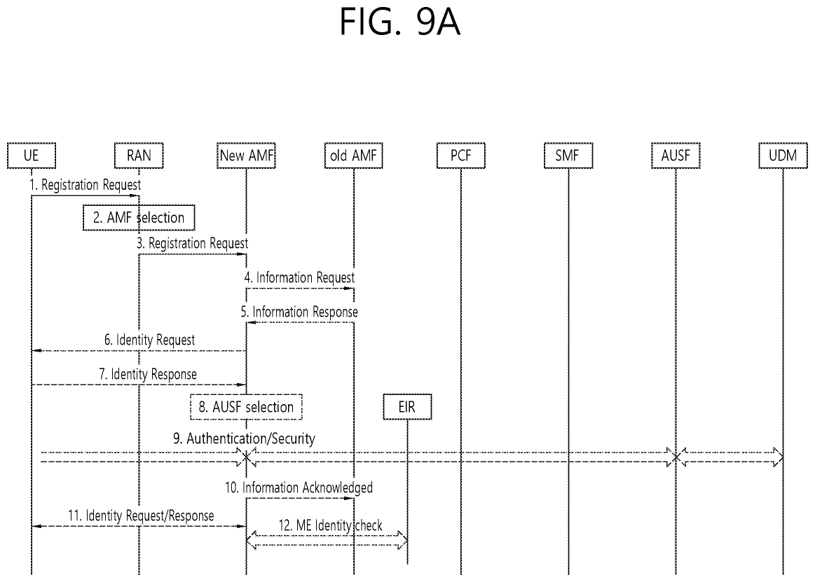

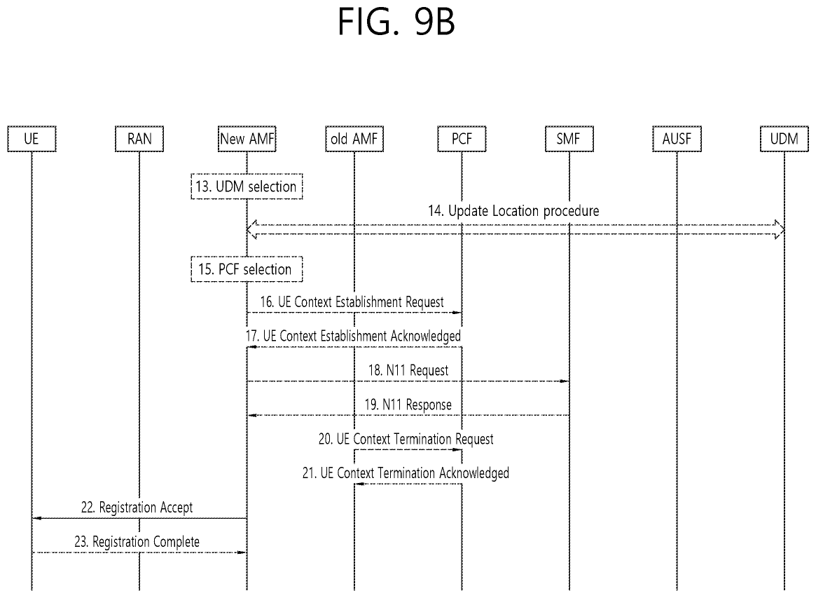

FIG. 9A is a signal flowchart illustrating an exemplary registration procedure. FIG. 9B is a signal flowchart illustrating an exemplary registration procedure continued from FIG. 9A.

For reference, the registration procedure shown in FIGS. 9A and 9B is an exemplary procedure, and the scope of the present disclosure is not limited thereto. That is, the registration procedure is performed by omitting the steps shown in FIGS. 9A and 9B, may be performed by modifying the steps shown in FIGS. 9A and 9B, or may be performed together with steps not shown in FIGS. 9A and 9B.

1) The UE may transmit an AN message to the RAN. The AN message may include an AN parameter and a registration request message. The registration request message may include information, such as a register type, a subscriber permanent ID or temporary user ID, a security parameter, NASSAI, 5G capability of the UE, a PDU session status, and so on.

In case of a 5G RAN, the AN parameter may include a SUPI or a temporary user ID, a selected network, and NASSAI.

The registration type may indicate whether the registration is an “initial registration” (i.e., the UE is in a non-registered state), “mobility registration update” (i.e., the UE is in a registered state, and the registration procedure is initiated by mobility), or “periodic registration update” (i.e., the UE is in a registered state, and the registration procedure is initiated due to the expiration of a periodic update timer). In case a temporary user ID is included, the temporary user ID indicates a last serving AMF. In case the UE has already been registered in a PLMN other than the PLMN of a 3GPP access through a non-3GPP access, the UE may not provide a UE temporary ID, which is allocated by the AMF during a registration procedure through the non-3GPP access.

The security parameter may be used for authentication and integrity protection.

The PDU session status indicates a PDU session that is available (and previously configured) in the UE.

2) In case the SUPI is included, or in case the temporary user ID does not indicate a valid AMF, the RAN may select an AMF based on a (R)AT and NSSAI.

In case the (R)AN cannot select an appropriate AMF, any AMF is selected according to a local policy, and the registration request is forwarded (or transferred) by using the selected AMF. If the selected AMF cannot provide service to the UE, the selected AMF may select another AMF that is more appropriate for the UE.

3) The RAN transmits an N2 message to a new AMF. The N2 message includes an N2 parameter and a registration request. The registration request may include a registration type, a subscriber permanent identifier or temporary user ID, a security parameter, NSSAI, MICO mode default settings (or configuration), and so on.

When a 5G-RAN is used, the N2 parameter includes location information related to a cell in which the UE is camping, a cell identifier, and a RAT type.

If the registration type indicated by the UE is a periodic registration update, Process 4 to Process 17, which will be described in detail later on, may not be performed.

4) The newly selected AMF may transmit an information request message to the previous AMF.

In case the temporary user ID of the UE is included in a registration request message, and in case the serving AMF is changed after the last registration, a new AMF may include an information request message, which includes complete registration request information for requesting SUPI and MM context of the UE, to the previous (or old) AMF.

5) The previous (or old) AMF transmits an information response message to the newly selected AMF. The information response message may include SUPI, MM context, and SMF information.

More specifically, the previous (or old) AMF transmits an information response message including SUPI and MM context of the UE.
In case information on an active PDU session is included in the previous (or old) AMF, SMF information including SMF ID and PDU session ID may be included in the information response message of the previous (or old) AMF.

6) In case the SUPI is not provided by the UE, or in case the SUPI is not searched from the previous (or old) AMF, the new AMF transmits an Identity Request message to the UE.

7) The UE transmits an Identity Response message including the SUPI to the new AMF.

8) The AMF may determine to perform triggering of an AUSF. In this case, the AMF may select an AUSF based on the SUPI.

9) The AUSF may initiate authentication of the UE and the NAS security function.

10) The new AMF may transmit an information response message to the previous (or old) AMF.

If the AMF is changed the new AMF may transmit the information response message in order to verify the forwarding of UE MM context.
If the authentication/security procedure is failed, the registration is rejected, and the new AMF may transmit a rejection message to the previous (or old) AMF.

11) The new AMF may transmit an Identity Request message to the UE.

In case a PEI is not provided by the UE, or in case a PEI is not searched from the previous (or old) AMF, an Identity Request message may be transmitted in order to allow the AMF to search the PEI.

12) The new AMF checks an ME identifier.

13) If Process 14, which will be described later on, is performed, the new AMF selects a UDM based on the SUPI.

14) If the AMF is modified after the final registration, if valid subscription context of the UE does not exist in the AMF, or if the UE provides a SUPI, wherein the AMF does not refer to a valid context, the new AMF initiates an Update Location procedure. Alternatively, even in a case where a UDM initiates Cancel Location for the previous AMF, the Update Location procedure may be initiated. The previous (or old) AMF discards the MM context and notifies all possible SMF(s), and, after obtaining AMF-related subscription data from the UDM, the new AMF generates MM context of the UE.

In case network slicing is used, the AMF obtains allowed NSSAI based on the requested NSSAI and UE subscription and local policy. In case the AMF is not appropriate for supporting the allowed NSSAI, the registration request is re-routed.

15) The new AMF may select a PCF based on the SUPI.

16) The new AMF transmits a UE Context Establishment Request message to the PCF. The AMF may request an operator policy for the UE to the PCF.

17) The PCF transmits a UE Context Establishment Acknowledged message to the new AMF.

18) The new AMF transmits an N11 request message to the SMF.

More specifically, when the AMF is changed, the new AMF notifies the new AMF that provides services to the UE to each SMF. The AMF authenticates the PDU session status from the UE by using available SMF information. In case the AMF is changed, the available SMF information may be received from the previous (or old) AMF. The new AMF may send a request to the SMF to release (or cancel) network resources related to a PDU session that is not activated in the UE.

19) The new AMF transmits an N11 response message to the SMF.

20) The previous (or old) AMF transmits a UE Context Termination Request message to the PCF.

In case the previous (or old) AMF has previously requested UE context to be configured in the PCF, the previous (or old) AMF may delete the UE context from the PCF.

21) The PCF may transmit a UE Context Termination Request message to the previous (or old) AMF.

22) The new AMF transmits a Registration Accept message to the UE. The Registration Accept message may include a temporary user ID, registration area, mobility restriction, PDU session status, NSSAI, periodic registration update timer, and allowed MICO mode.

In case the AMF allocated a new temporary user ID, the temporary user ID may be further included in the Registration Accept message. In case the mobility restriction is applied to the UE, information indicating the mobility restriction may be additionally included in the Registration Accept message. The AMF may include information indicating the PDU session status for the UE in the Registration Accept message. The UE may remove any internal resource being related to a PDU session that is not marked as being active from the received PDU session status. If the PDU session status information is included in the Registration Request, the AMF may include the information indicating the PDU session status to the UE in the Registration Accept message.

23) The UE transmits a Registration Complete message to the new AMF.

<PDU Session Establishment Procedure>

For the PDU Session Establishment procedure, two different types of PDU Session Establishment procedures may exist as described below.
A PDU Session Establishment procedure initiated by the UE.
A PDU Session Establishment procedure initiated by the network. For this, the network may transmit a Device Trigger message to an application (or applications) of the UE.

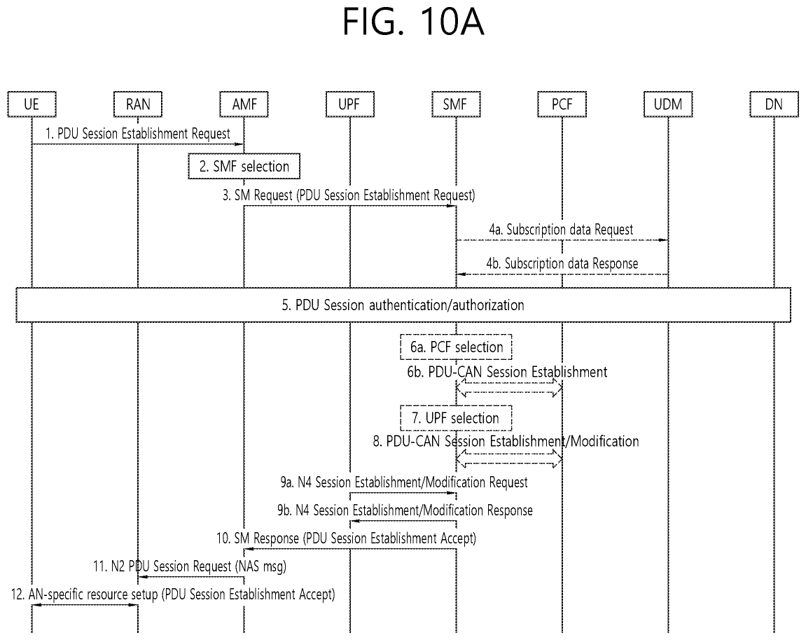

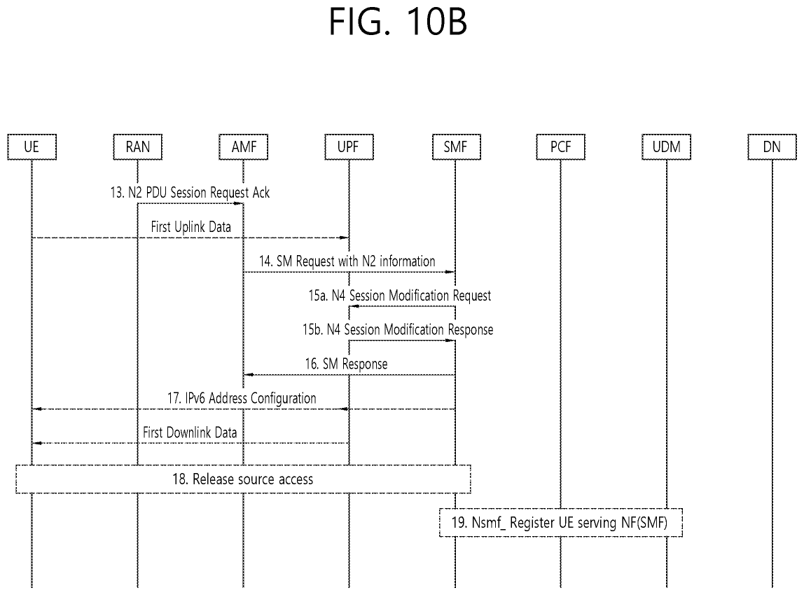

FIG. 10A is a signal flowchart illustrating an exemplary PDU session establishment procedure. FIG. 10B is a signal flowchart illustrating an exemplary PDU session establishment procedure continued from FIG. 10A.

The procedure shown in FIGS. 10A and 10B assumes that the UE has already registered on the AMF according to the registration procedure shown in FIGS. 9A and 9B. Therefore, it is assumed that the AMF has already acquired user subscription data from UDM. For reference, the PDU session establishment procedure shown in FIGS. 10A and 10B is an exemplary procedure, and the scope of the present disclosure is not limited thereto. That is, the PDU session establishment procedure may be performed by omitting the steps shown in FIGS. 10A and 10B, or may be performed by modifying the steps shown in FIGS. 10A and 10B, or may be performed together with steps not shown in FIGS. 10A and 10B.

1) The UE transmits a NAS message to the AMF. The message may include Single-Network Slice Selection Assistance Information (S-NSSAI), DNN, PDU session ID, a Request type, N1 SM information (including PDU Session Request), and so on.

In order to establish a new PDU session, the UE may generate a new PDU session ID.

By transmitting a NAS message having a PDU Session Establishment Request message included in N1 SM information, the PDU Session Establishment procedure that is initiated by the UE may be started. The PDU Session Establishment Request message may include a Request type, an SSC mode, and a protocol configuration option.

In case the PDU Session Establishment is for configuring a new PDU session, the Request type indicates “initial access”. However, in case an existing PDU session exists between the 3GPP access and the non-3GPP access, the Request type may indicate an “existing PDU session”.

The NAS message being transmitted by the UE is encapsulated within an N2 message by the AN. The N2 message is transmitted to the AMF and may include user location information and access technique type information.
The N1 SM information may include an SM PDU DN request container including information on a PDU session authentication performed by an external DN.

2) In case the request type indicates an “initial request”, and in case the PDU session ID has not been used for the existing PDU session of the UE, the AMF may determine that the message corresponds to a request for a new PDU session.

If the NAS message does not include the S-NSSAI, the AMF may determine default S-NSSAI for the requested PDU session according to the UE subscription. The AMF may relate a PDU session ID with an ID of the SMF and may store the PDU session ID.

3) The AMF transmits an SM request message to the SMF. The SM request message may include a subscriber permanent ID, DNN, S-NSSAI, a PDU session ID, an AMD IF, N1 SM information, user location information, and an access technique type. The N1 SM information may include a PDU session ID and a PDU Session Establishment Request message.

The AMF ID is used for identifying an AMF providing services to the UE. The N1 SM information may include the PDU Session Establishment Request message, which is received from the UE.

4a) The SMF transmits a Subscriber Data Request message to the UDM. The Subscriber Data Request message may include a subscriber permanent ID and DNN.

In the above-described Process 3, in case the Request type indicates an “existing PDU session”, the SMF determines that the corresponding request is caused by a handover between the 3GPP access and the non-3GPP access. The SMF may identify the existing PDU session based on the PDU session ID.

In case the SMF has not yet searched the SN-related subscription data for the UE that is related to the DNN, the SMF may request the subscription data.

4b) The UDM may transmit a Subscription Data Response message to the SMF.

The subscription data may include an authenticated Request type, an authenticated SSC mode, and information on a default QoS profile.

The SMF may verify whether or not the UE request follows the user subscription and local policy. Alternatively, the SMF may reject the UE request via NAS SM signaling (including the related SM rejection cause), which is forwarded (or transferred) by the AMF, and then the SMF may notify to the AMF that this shall be considered as a release of the PDU session ID.

5) The SMF transmits a message to the DN through a UPF.

More specifically, in case the SMF is required to authorize/authenticate a PDU session establishment, the SMT selects a UPF and triggers the PDU.

If the PDU Session Establishment authentication/authority assignment fails, the SMF ends the PDU Session Establishment procedure and notifies the rejection to the UE.

6a) If dynamic PCC is distributed, the SMF selects a PCF.

6b) The SMF may start a PDU-CAN session establishment towards the PCF in order to obtain a default PCC rule for the PDU session. In case the Request type indicates an “existing PDU session”, the PCF may start a PDU-CAN session modification instead.

7) In case the Request type of Process 3 indicates an “initial request”, the SMF selects an SSC mode for the PDU session. If Process 5 is not performed, the SMF may also select a UPF. In case of Request type IPv4 or IPv6, the SMF may allocate an IP address/prefix for the PDU session.

8) In case dynamic PCC is deployed and the PDU-CAN session establishment is not yet completed, the SMF may begin (or start) PDU-CAN Session Start.

9) In case the Request type indicates an “initial request”, and in case Process 5 is not performed, the SMF may use the selected UPF and start an N4 Session Establishment procedure. And, otherwise, the SMF may use the selected and start an N4 Session Modification procedure.

9a) The SMF transmits an N4 Session Establishment/Modification request message to the UPF. And, the SMF may provide packet discovery, execution, and reporting rules of packets that are to be installed in the UPF for the PDU session. In case the SMF allocates CN tunnel information, the CN tunnel information may be provided to the UPF.

9b) By transmitting an N4 Session Establishment/Modification response message, the UPF may respond. In case the CN tunnel information is allocated by the UPF, the CN tunnel information may be provided to the SMF.

10) The SMF transmits an SM response message to the AMF. The message may include a cause, N2 SM information, and N1 SM information. The N2 SM information may include a PDU session ID, a QoS profile, and CN tunnel information. The N1 SM information PDU Session Establishment Accept message. The PDU Session Establishment Accept message may include an allowed QoS rule, an SSC mode, S-NSSAI, and allocated IPv4 address.

As information that shall be forwarded to the RAN by the AMF, the N2 SM information may include the following.
CN Tunnel information: This corresponds to a core network address of an N3 tunnel corresponding to the PDU session.
QoS Profile: This is used for providing mapping between a QoS parameter and a QoS flow identifier (QFI) to the RAN.
PDU Session ID: This may be used for indicating a relation between AN resources for the UE and the PDU session to the UE via AN signaling for the UE.

Meanwhile, the N1 SM information includes a PDU Session Establishment Accept message that shall be provided to the UE by the AMF.

Multiple QoS rules may be included in the N1 SM information and the N2 SM information within the PDU Session Establishment Accept message.
The SM response message also includes information enabling the PDU session ID and AMF to determine not only which target UE to use but also which access is to be used for the UE.

11) The AMF transmits an N2 PDU Session Request message to the RAN. The message may include N2 SM information and an NAS message. The NAS message may include a PDU session ID and a PDU Session Establishment Accept message.

The AMF may transmit an NAS message including a PDU session ID and a PDU Session Establishment Accept message. Additionally, the AMF may include the N2 SM information received from the SMF in the N2 PDU Session Request message and may then transmit the message including the N2 SM information to the RAN.

12) The RAN may perform a specific signaling exchange with a UE being related to the information received from the SMF.

The RAN also allocates RAN N3 tunnel information for the PDU session.

The RAN forwards the NAS message, which is provided in Process 10. The NAS message may include a PDU session ID and N1 SM information. The N1 SM information may include a PDU Session Establishment Accept message.

The RAN transmits the NAS message to the UE only in a case where a needed RAN resource is configured and allocation of RAN tunnel information is successful.

13) The RAN transmits an N2 PDU Session Response message to the AMF. The message may include a PDU session ID, a cause, and N2 SM information. The N2 SM information may include a PDU session ID, (AN) tunnel information, and a list of allowed/rejected QoS profiles.
The RAN tunnel information may correspond to an access network address of an N3 tunnel corresponding to the PDU session.

14) The AMF may transmit an SM Request message to the SMF. The SM Request message may include N2 SM information. Herein, the AMF may forward the N2 SM information received from the RAN to the SMF.

15a) In an N4 session for the PDU session has not already been configured, the SMF may start an N4 Session Establishment procedure along with the UPF. Otherwise, the SMF may use the UPF to start an N4 Session Modification procedure. The SMF may provide AN tunnel information and CN tunnel information. The CN tunnel information shall be provided only in a case where the SMF selects the CN tunnel information in Process 8.

15b) The UPF may transmit an N4 Session Establishment/Modification Response message to the SMF.

16) The SMF may transmit an SM Response message to the AMF. When this process is ended (or completed), the AMF may forward the related event to the SMF. This occurs during a handover, in which the RAN tunnel information is modified or the AMF is re-deployed.

17) The SMF transmits information to the UE through the UPF. More specifically, in case of PDU Type IPv6, the SMF may generate an IPv6 Router Advertisement and may transmit the generated advertisement to the UE through the N4 and UPF.

18) In case the PDU Session Establishment Request is caused by a handover between the 3GPP access and the non-3GPP access, i.e., if the Request type is configured as an “existing PDU session”, the SMF releases the user plane through a source access (3GPP or non-3GPP access).

19) In case the ID of the SMF is not included in Process 4b by the UDM of the DNN subscription context, the SMF may call (or page or summon) a “UDM Register UE serving NF service” including an SMF address and DNN. The UDM may store the ID, address, and DNN of the SMF.

During the procedure, if the PDU Session Establishment is not successful, the SMF notifies this to the AMF.

1. Procedure Related to the Disclosure of this Specification

<Service Request Procedures>

The service request procedure is used to request establishment of a secure connection to AMF by a UE or a 5G core network (5GC). The service request procedure is used to activate the user plane connection of the established PDU session even when the UE is in a CM-IDLE state and a CM-CONNECTED state. For reference, in order to reflect NAS signaling connection between the AMF and the UE, two CM states of the CM-IDLE state and the CM-CONNECTED state are used.

The UE does not initiate a service request procedure if there is an ongoing service request procedure.

The service request procedure includes a service request procedure initiated by the UE (i.e., a UE triggered service request) and a service request procedure initiated by the network (i.e., a network triggered service request).

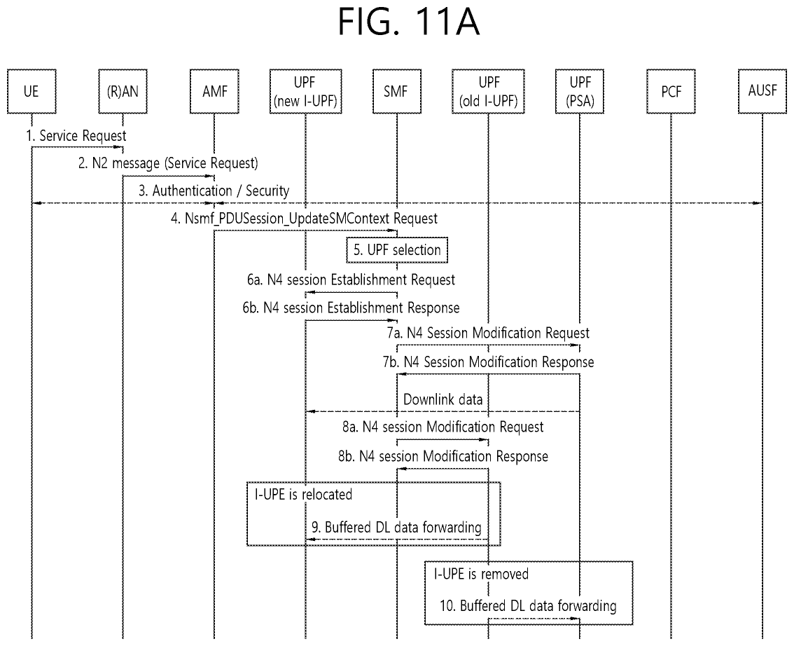

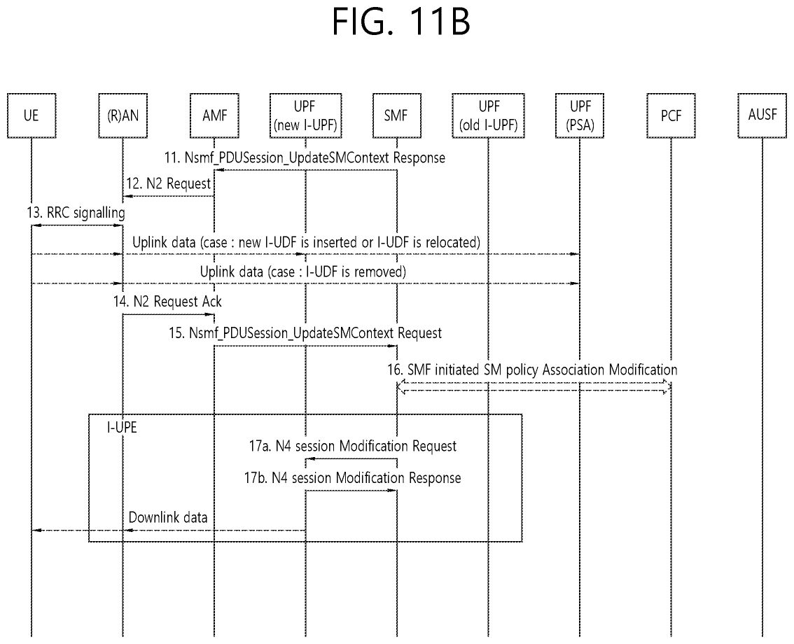

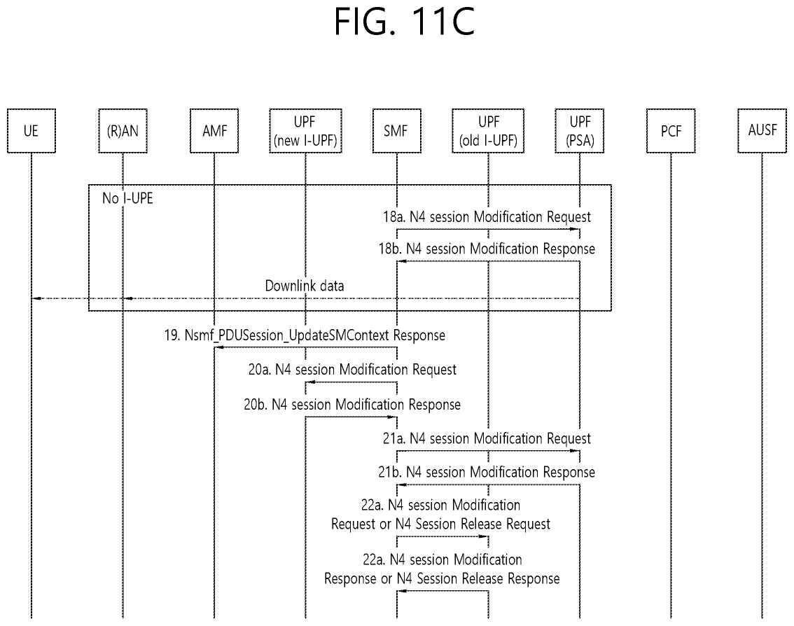

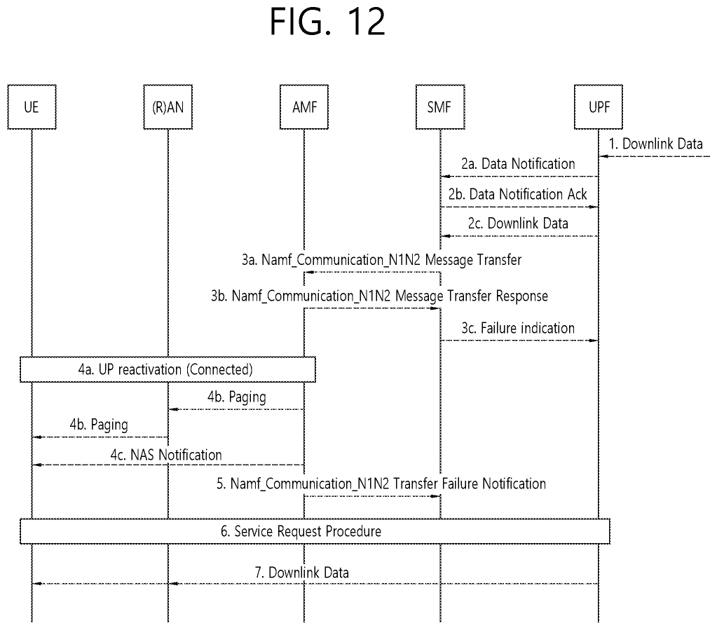

Hereinafter, an example of the UE triggered service request procedure will be described with reference to FIGS. 11A to 11C, and an example of the network triggered service request procedure will be described with reference to FIG. 12. The service request procedure described in FIGS. 11A to 11C and 12 is only an example, and the service request procedure in the present disclosure includes all the service request procedures triggered by the UE and all the service request procedures triggered by the network.

FIGS. 11A to 11C are signal flowcharts illustrating an exemplary UE triggered service request procedure.

The UE in the CM-ILDE state initiates a service request procedure to transmit a response on an uplink signaling message, user data, or network paging request. After receiving the service request message, the AMF may perform authentication. After establishing a signaling connection for AMF, the UE or the network may transmit a signaling message (e.g., establishment of a PDU session from the UE to the SMF through the AMF).

The service request procedure may be used by a UE in CM-CONNECTED state to request activation of a user plane connection for a PDU session and to respond to a NAS notification message received from the AMF.

For any service request procedure, if necessary, the AMF may include state information of the PDU session in a service accept message to synchronize a PDU session state between the UE and the network.

If the service request is not accepted by the network, the AMF responds to the UE with a service reject message. The service rejection message may include an indication or a cause code for requesting that the UE perform a registration update procedure.

In the UE triggered service request procedure, both SMF and UPF belong to a PLMN that serves the UE. For example, in a home routed roaming case, the SMF and UPF of the HPLMN are not affected by the service request procedure (that is, the SMF and UPF of the HPLMN are not involved in the service request procedure).

In response to a service request according to user data, the network may take additional action if the user plane connection activation is not successful.

The UE triggered service request procedure may be applied to a scenario with or without an intermediate UPF and a scenario with or without an intermediate UPF reselection.

1) Signaling from UE to (R)AN: the UE may transmit an access network (AN) message (including AN parameters, service request (list of PDU sessions to be activated, list of allowed PDU sessions), security parameters and PDU session status (status)) to the (R)AN.

The list of PDU sessions to be activated is provided by the UE when the UE attempts to re-activate the PDU session. The list of allowed PDU sessions is provided by the UE when the service request is a response to a NAS notification or paging of a PDU session related to non-3GPP access. And, the list of allowed PDU sessions identifies PDU sessions that may be moved to 3GPP access.

In case of NG-RAN:
AN parameters include the selected PLMN ID and establishment cause. The establishment cause provides a reason for requesting establishment of an RRC connection.
The UE transmits a service request message (message to AMF) encapsulated in an RRC message to the NG-RAN. The RRC message may be used to carry 5G system architecture evolution (SAE)-temporary mobile subscriber identity) (5G-S-TMSI).

When a service request is triggered for user data, the UE notifies a PDU session in which a user plane (UP) connection is to be activated in a service request message using a list of PDU sessions to be activated.

When the service request is triggered only for signaling, the UE does not include a list of PDU sessions to be activated.

When a service request procedure is triggered for a paging response and the UE has user data to be transmitted at the same time, the UE may inform about the PDU session with a UP connection to be activated in the service request message using the list of PDU sessions to be activated. Otherwise, the UE does not inform about any PDU session in the service request for paging response.

In a specific case, if there is no pending uplink data of PDU sessions, if a service request is triggered only for signaling, or if a service request is triggered for a paging response, the UE may include the PDU session to the list of PDU sessions to be activated.

When a service request through 3GPP access is triggered in response to a NAS notification indicating paging or non-3GPP access, the UE includes the non-3GPP PDU session that may be reactivated through 3GPp in the allowed PDU session list (See the example to be described in step 6 of FIG. 12).

The PDU session state indicates a PDU session available in the UE.

When the UE is located outside an available area of the LADN, the UE does not trigger a service request procedure for a PDU session corresponding to the LADN. Also, when the service request is triggered for other reasons, the UE does not include the PDU session in the list of PDU sessions to be activated.

When the UE is in the CM-CONNECTED state, only a list of PDU sessions to be activated and a list of allowed PDU sessions may be included in the service request.

2) (R)AN to AMF signaling: (R)AN may transmit an N2 message to AMF. The N2 message may include N2 parameters, a service request, and a UE context request.

If the AMF cannot handle the service request, the AMF will reject the service request.

When NG-RAN is used, N2 parameter may include 5G-S-TMSI, the selected PLMN ID, location information, and establishment cause.

When the UE is in the CM-IDLE state, the NG-RAN may acquire 5G-S-TMSI in the RRC procedure. The NG-RAN may select AMF based on 5G-S-TMSI. The location information is related to a cell on which the UE camps.

Based on the PDU session state, the AMF may perform a PDU session release procedure for PDU sessions indicated by the UE that the PDU session ID is not available in the network.

3a) Signaling from AMF to (R)AN: AMF may transmit an N2 request to (R)AN. Here, the N2 request may include a security context, a handover restriction list, and a list of recommended cells/TAs/NG-RAN node identifiers.

When the 5G-AN requests for the UE context or the AMF needs to provide the UE context (e.g., when the AMF needs to initiate a fallback procedure for an emergency service), the AMF may initiate an NG application protocol (NGAP) procedure. For a UE in a CM-IDLE state, the 5G-AN stores security context in the UE AN context. The handover restriction list is related to mobility restrictions.

The 5G-AN uses the security context to protect messages exchanged with the UE.

When the NG-RAN node provides a list of recommended cells/TAs/NG-RAN node identifiers during the AN release procedure, the AMF may include the list of recommended cells/TAs/NG-RAN node identifiers in the N2 request. When the RAN determines to enable the RRC inactive state for the UE, the RAN may use this information to allocate a RAN notification area.

3) If the service request is not transmitted as being integrity protected or integrity protection verification failed, the AMF may initiate a NAS authentication/security procedure.

When the UE in the CM-IDLE state initiates a service request only for signaling connection, the UE and the network may exchange NAS signaling after successful establishment of the signaling connection, and steps 4 to 11 and steps 15 to 22 of FIGS. 11A to 11C may be omitted.

4) [Conditional Operation] Signaling from AMF to SMF: The AMF may transmit an Nsmf_PDUSession_UpdateSMContext Request to the SMF. Here, the Nsmf_PDUSession_UpdateSMContext Request may include a PDU session ID, operation type, UE location information, access type, RAT type, and UE presence in LADN service area.

Nsmf_PDUSession_UpdateSMContext Request is invoked in the following cases:
When the UE includes a list of PDU sessions to be activated in the service request message;
When this procedure is triggered by the SMF but a PDU session identified by the UE is correlated with a PDU session ID different from the PDU session ID that triggers this procedure;
When this procedure is triggered by the SMF but a current UE location is outside the “area of validity for the N2 SM information” provided by the SMF (see step 3a in FIG. 12). In this case, the AMF does not transmit the N2 information provided by the SMF (see step 3a in FIG. 12). If the current UE location is outside the “available area of N2 SM information”, steps 4 to 11 are omitted.

If the DNN corresponds to the LADN, “the presence of the UE in the LADN service area” indicates whether the UE is inside (IN) or outside (OUT) the LADN service area. If the AMF does not provide an indication of “the presence of a UE in the LADN service area” and the SMF determines that the DNN corresponds to the LADN, the SMF considers the UE to be outside the LADN service area.

The AMF determines whether the PDU session(s) will be activated. In addition, the AMF transmits the Nsmf_PDUSession_UpdateSMContext Request related to the PDU session to the SMF along with an operation type set to “UP active” to indicate establishment of the user plane resource for the PDU session. The AMF determines an access type and an RAT type based on a global RAN node ID related to an N2 interface.

If this procedure is triggered in response to a paging or NAS notification indicating non-3GPP access and the UE is not on the list (provided by the UE) of PDU sessions allowed in the paged or notified PDU session, the AMF may notify the SMF that the user plane for the PDU session cannot be reactivated. The service request procedure may be terminated without reactivation of the user plane for other PDU sessions in the list of allowed PDU sessions.

While the previous NAS signaling connection through the NG-RAN is maintained, the AMF may receive a service request through the NG-RAN to establish another NAS signaling connection. In this case, in order to release the previous NAS signaling connection, AMF may trigger an AN release procedure for the old NG-RAN according to the following logic:
For the PDU session indicated in the “list of PDU sessions to be activated”, the AMF may request the SMF to immediately activate the PDU session by performing this step 4.
For a PDU session included in the “list of PDU session ID(s) with active N3 user plane” but not included in the “list of PDU sessions to be activated”, the AMF may request the SMF to deactivate the PDU session.

5) If the PDU session ID corresponds to the LADN and the SMF determines that the UE is located outside the available area of the LADN based on the “UE presence in the LADN service area” provided by the AMF, the SMF may determine to perform the following actions (based on a local policy).
SMF may maintain the PDU session. However, the SMF may reject the activation of the user plane connection of the PDU session and notify the AMF accordingly. When the service request procedure is triggered by the network initiated service request of FIG. 12, the SMF may notify the UPF (UPF that has sent data notification) that the UPF should discard downlink data for the PDU session and/or should not provide an additional data notification message; or
The SMF may release the PDU session: The SMF may release the PDU session and inform the AMF that the PDU session has been released.
In the above two cases, the SMF responds to the AMF with an appropriate reject cause, and user plane activation of the PDU session may be stopped.

When the SMF determines that the UE is located in the LADN available area, the SMF may check a UPF selection criterion based on the location information received from the AMF and determine to perform one of the following operations:
The SMF accepts the activation of the UP connection and may continue to use the current UPF;
When the UE moves outside the service area of the UPF (the UPF previously connected to the AN), the SMF, while maintaining the UPF acting as a PDU session anchor, may accept activation of the UP connection and select a new intermediate UPF (or may add/remove intermediate UPFs (I-UPF)). The steps to perform the addition/change/removal of the I-UPF are described below through conditional steps.

NOTE 1: When old and/or new I-UPF implements a UL uplink classifier (CL) or branching point (BP) function and a PDU session anchor for connectivity of local access to the data network, the signaling described in this figure is intended as signaling for adding, removing, or changing a PDU session anchor, and signaling for adding, releasing, or changing UL CL or BP, should be performed by a different procedure.
The SMF may reject activation of the UP connection of the PDU session in session and service continuity (SSC) mode 2. In addition, after the service request procedure, the SMF may trigger re-establishment of a PDU session in order to perform allocation of a new UPF (UPF acting as a PDU session anchor). (This operation may be performed, for example, when the UE is moved outside the service area of the anchor UPF connected to the NG-RAN)

6a) [Conditional operation] Signaling from SMF to new UPF (or new I-UPF): The SMF may transmit an N4 session establishment request to the UPF.

When the SMF selects a new UPF acting as an I-UPF for a PDU session or when the SMF chooses to insert an I-UPF for a PDU session (which did not have an I-UPF), the SMF may transmit a N4 session establishment request to the UPF. Here, the N4 establishment request provides packet detection to be installed in the I-UPF, data forwarding, enforcement, and reporting rules. PDU session anchor addressing information for a PDU session (PDU session anchor addressing information at an N9 reference point (a reference point between two UPFs)) is also provided to the I-UPF.

When a service request is triggered by the network, and the SMF selects a new UPF to replace the existing UPF (or the existing I-UPF), the SMF may include a data forwarding indication in the N4 session establishment request. The data forwarding indication may indicate to the UPF that second tunnel endpoint needs to be reserved for DL data buffered after being provided from the previous I-UPF.

6b) Signaling from new UPF (or I-UPF) to the SMF: The new UPF (or I-UPF) may transmit an N2 session establishment response (N4 Session establishment response) to the SMF.

The new I-UPF may transmit an N4 session establishment response to the SMF. When the UPF allocates CN tunnel information, the new I-UPF may transmit DL core network (CN) tunnel information for the UPF acting as a PDU session anchor and UL tunnel information of the new I-UPF to the SMF. When a data transfer indication is received, a new UPF (or I-UPF) operating as an N3 terminating point may transmit DL tunnel information of the new I-UPF to the SMF for data transmission from the existing UPF (or I-UPF) to the SMF. If the previous I-UPF resource exists, the SMF may drive a timer to be used in step 22a to release the corresponding resource.

7a) [Conditional operation] Signaling from SMF to UPF (PSA: PDU session anchor) signaling: SMF may transmit an N4 session modification request to the UPF.

When the SMF selects a new UPF to operate as an I-UPF for a PDU session, the SMF may transmit an N4 session modification request message to the PDU session anchor UPF to provide DL tunnel information received from the new I-UPF. When a new I-UPF is added for a PDU session, the UPF (PSA) may provide DL data to the new I-UPF as indicated in the DL tunnel information.

If a service request is triggered by the network and the SMF removes the existing I-UPF and does not replace the existing I-UPF with a new I-UPF, the SMF may include the data forwarding indication in the N4 session modification request. The data forwarding indication may indicate to the UPF (PSA) that the second tunnel endpoint needs to be reserved for buffered DL data received from the existing I-UPF. In this case, the UPF (PSA) may start buffering DL data that may be simultaneously received from the N6 interface.

7b) The UPF (PSA) may transmit an N4 session modification response message to the SMF.

When the UPF (PSA) receives the data forwarding indication, the UPF (PSA) becomes an N3 endpoint and the UPF (PSA) may transmit CN DL tunnel information for the previous UPF (or I-UPF) to the SMF. The SMF may start a timer. If the previous I-UPF resource exists, the SMF may drive a timer to be used in step 22a in order to release the corresponding resource.

When the UPF connected to the RAN is a UPF (PSA) and the SMF receives Nsmf_PDUSession_UpdateSMContext Request (including operation type set to “UP activate” to indicate establishment of user plane resource for the PDU session), if the SMF finds that the PDU session is active, the SMF may initiate an N4 session modification procedure to remove the AN tunnel information and remove the AN tunnel information from the UPF.

8a) [Conditional operation] Signaling from SMF to existing UPF (or I-UPF): The SMF may transmit N4 session modification (including new UPF address, new UPF DL tunnel ID) to the existing UPF (or I-UPF).

When a service request is triggered by the network and the SMF removes the existing UPF (or I-UPF), the SMF may transmit an N4 session modification request message to the existing UPF (or I-UPF) to provide DL tunnel information for buffered DL data. When the SMF allocates a new I-UPF, the DL tunnel information is received from a new UPF (or I-UPF) operating as an N3 endpoint. If the SMF does not allocate a new I-UPF, the DL tunnel information is transmitted from the UPF (PSA) operating as an N3 endpoint. The SMF may drive a timer for monitoring a forwarding tunnel as in step 6b or 7b.

When the SMF receives the Nsmf_PDUSession_UpdateSMContext Request of step 4 (including an operation type set to “UP activate” to instruct establishment of user plane resources for the PDU session), if the SMF knows that the PDU session has been activated, the SMF may remove the AN tunnel information to remove tunnel information of the AN in the UPF and may initiate an N4 session modification procedure.

8b) Signaling from the existing UPF (or I-UPF) to the SMF: The existing UPF (or I-UPF) may transmit an N4 session modification response message to the SMF.

9) [Conditional operation] Signaling from an existing UPF (or I-UPF) to a new UPF (or I-UPF): The existing UPF (or I-UPF) may deliver downlink data buffered with a new UPF (or I-UPF).

When the I-UPF is changed and a forwarding tunnel is established for a new I-UPF, the existing UPF (or I-UPF) transfers the buffered data to the new UPF (or I-UPF) operating as an N3 endpoint.

10) [Conditional operation] Signaling from the existing UPF (or I-UPF) to the UPF (PSA): The existing UPF (or I-UPF) may transfer buffered downlink data to the UPF (PSA).

When the existing I-UPF is removed, the new I-UPF is not allocated t the PDU session, and a forwarding tunnel is established for the UPF (PSA), the existing UPF (or I-UPF) may transfer the data buffered to the existing UPF (or I-UPF) to a new UPF (PSA) acting as an N3 endpoint.

11) [Conditional Operation] Signaling from SMF to AMF: SMF may transmit Nsmf_PDUSession_UpdateSMContext Response to AMF. Nsmf_PDUSession_UpdateSMContext Response may include N2 SM information (PDU session ID, QFI(s) (QoS Flow ID), quality of service (QoS) profile, CN N3 tunnel information, S-NSSAI, user plane security enforcement, UE integrity protection maximum data rate, and a cause. When the UPF connected to the RAN is UPF (PSA), the CN N3 tunnel information is UL tunnel information of UPF (PSA). When the UPF connected to the RAN is a new I-UPF, the CN N3 tunnel information is UL tunnel information of the I-UPF.

For the PDU session in which the SMF determines to accept the activation of the UP connection in step 5, the SMF may generate only N2 SM information and transmit an Nsmf_PDUSession_UpdateSMContext Response to the AMF to establish a user plane. The N2 SM information may include information to be provided by AMF to the NG-RAN. When the SMF determines to change the PSA UPF for the SSC mode 3 PDU session, the SMF may trigger a change of the SSC mode 3 PDU session anchor as an independent procedure after accepting UP activation of the PDU session.

The SMF may reject the activation of the UP of the PDU session by including the cause in the Nsmf_PDUSession_UpdateSMContext Response. The SMF may reject activation of the UP of the PDU session in the following cases, for example:
When the PDU session corresponds to the LADN and the UE is located outside the available area of the LADN as in step 5;
When the AMF informs the SMF that the UE is reachable only for a regulatory prioritized service and the PDU session to be activated is not for the regulatory prioritized service; or
When the SMF determines to change the PSA UPF for the requested PDU session as in step 5. In this case, after the SMF transmits the Nsmf_PDUSession_UpdateSMContext Response, the SMF may perform another procedure to instruct the UE to re-establish the PDU session for SSC mode 2.
If the SMF receives a negative response in step 6b due to UPF resource unavailability.

When an EPS bearer ID is assigned to a PDU session, the SMF maps the EPS bearer ID and QFI to N2 SM information and transmits the same to the NG-RAN.

User plane security enforcement information is determined by the SMF during a PDU session establishment procedure. When integrity protection indicates “preferred” or “required”, the SMF may also include UE integrity protection maximum data rate in the user plane security enforcement information.

12) Signaling from AMF to (R)AN: The AMF may transmit an N2 request to (R)AN. N2 request may include N2 SM information received from the SMF, security context, handover restriction list, subscribed UE-aggregate maximum bit rate (AMBR), MM NAS service acceptance (a list of recommended cells/TAs/NG-RAN node identifiers, and UE radio capability. Allowed NSSAI for the access type of the UE may be included in the N2 message.

When the UE triggers a service request while in the CM-CONNECTED state, only N2 SM information received from the SMF and MM NAS service acceptance may be included in the N2 request.

While the UE is in the CM-CONNECTED state, when a service request procedure is triggered by the network, only N2 SM information received from the SMF may be included in the N2 request.

When the service request procedure is triggered, the NG-RAN may store the security context and the NAS signaling connection Id for the UE in the CM-IDLE state. When the service request is not triggered by the UE only for the signaling connection, the RAN may store QoS information for a QoS flow of the activated PDU session, an N3 tunnel ID of the UE RAN context, and a handover restriction list.

MM NAS service acceptance may include a PDU session state of the AMF. During the session request procedure, certain local PDU session release may be notified to the UE through the PDU session state. The service acceptance message includes a PDU session reactivation result. The PDU session reactivation result provides an activation result for the PDU session of the allowed PDU session list which has generated a PDU session in the list of allowed PDU sessions and paging or NAS notification. If the PDU session reactivation result of the PDU session is failure, a cause of the failure may also be provided.

When there are a plurality of PDU sessions related to a plurality of SMFs, the AMF does not need to wait for a response from all SMFs in step 11. However, the AMF must wait for all responses from the plurality of SMFs before transmitting an MM NAS service acceptance message to the UE.

When step 12 is triggered for PDU session user plane activation, the AMF may include at least one N2 SM information received from the SMF in the N2 request. When there is additional N2 SM information received from the SMF, the AMF may include the additional N2 SM information received from the SMF in a separate N2 message (e.g., N2 tunnel setup request) and transmit the same. Alternatively, when a plurality of SMFs are involved, after all Nsmf_PDUSession_UpdateSMContext response service operations related to the UE are received from the SMF, the AMF may transmit one N2 request message to the (R)AN.

When the NG-RAN node provides a list of recommended cells/TAs/NG-RAN node identifiers during the AN release procedure, the AMF may include a list of recommended cells/TAs/NG-RAN node identifiers in the N2 request. When the NG-RAN determines to enable the RRC inactive state for the UE, the NG-RAN may use this information to allocate the RAN notification area.

The AMF based on the network configuration may include “RRC inactive assistance information” of the UE in the N2 request.

If possible, the AMF may include UE radio capability information in the N2 request and transmit the same to the NG-RAN node.

13) Signaling from (R)AN to UE: The NG-RAN may perform RRC connection reconfiguration with the UE. Specifically, the NG-RAN may perform RRC connection reconfiguration with the UE according to QoS information on all QoS flows of a data radio bearer and a PDU session in which the UP connection is activated. For the UE that was in the CM-IDLE state, if the service request is not triggered by the UE only for a signaling connection, user plane security may be established in this step. For the UE in the CM-IDLE state, when a service request is triggered by the UE only for signaling connection, the AS security context may be established in this step.

When the N2 request includes a NAS message, the NG-RAN may deliver the NAS message to the UE. The UE deletes the context of the PDU session that is not available in 5GC locally.

NOTE 2: The reception of the service acceptance message may not mean that the user plane radio resource has been successfully activated.

After the user plane radio resource is set up, uplink data from the UE may now be delivered to the NG-RAN. The NG-RAN may transmit uplink data to the UPF address and tunnel ID provided in step 11.

14) [Conditional operation] Signaling from (R)AN to AMF: The (R)AN may transmit acknowledgement for N2 request to the AMF. For example, the (R)AN may transmit an N2 request Ack to the AMF. Here, the N2 request Ack may include N2 SM information (including AN tunnel information, list of accepted QoS flows for the PDU sessions whose UP connections are activated and a list of rejected QoS Flows for the PDU Sessions whose UP connections are activated) and a PDU session ID.

The message including the N2 request Ack may include N2 SM information (e.g., AN tunnel information). When the AMF transmits a separate N2 message in step 11, the NG-RAN may respond to N2 SM information with a separate N2 message.

When a plurality of N2 SM messages are included in the N2 request message of step 12, the N2 request Ack may include a plurality of N2 SM information and information enabling the AMF to associate a response with a related SMF.

15) [Conditional operation] Signaling from AMF to SMF: The AMF may transmit an Nsmf_PDUSession_UpdateSMContext request (including N2 SM information, RAT type, and access type) per PDU session to the SMF. The AMF may determine the access type and the RAT type based on the global RAN node ID associated with the N2 interface.

When the AMF receives the N2 SM information (one or more) in step 14, the AMF may deliver the N2 SM information to the related SMF per PDU session ID. When a UE time zone is changed compared to a previously reported UE time zone, the AMF may include UE time zone information element (IE) in the Nsmf_PDUSession_UpdateSMContext request.

16) [Optional action] Signaling from SMF to PCF: When dynamic PCC is distributed, SMF performs SMF initiated SM policy modification procedure to initiate notification of new location information to the PCF (if subscribed). The PCF may provide updated policies.

17a) [Conditional operation] Signaling from the SMF to new I-UPF: The SMF may transmit an N4 session modification request to a new I-UPF. The N4 session modification request may include AN tunnel information and a list of accepted QFIs.

When the SMF selects a new SMF to operate as an I-UPF for the PDU session in step 5, the SMF may initiate an N4 session modification procedure for the new I-UPF and provide AN tunnel information. Downlink data from the new I-UPF may be delivered to the NG-RAN and UE.

17b) [Conditional Operation] Signaling from UPF to SMF: The UPF may transmit an N4 session modification response to the SMF.

18a) [Conditional operation] Signaling from SMF to UPF (PSA): The SMF may transmit an N4 session modification request to UPF (PSA). The N4 session modification request may include AN tunnel information and a list of rejected QoS flows.

If the user plane is set up or modified and if there is no I-UPF after modification, the SMF may initiate the N4 session modification procedure for the UPF (PSA) and provide AN tunnel information. Downlink data from the UPF (PSA) may now be delivered to the NG-RAN and UE.

For QoS flows in the list of rejected QoS flows, the SMF may instruct the UPF to remove rules related to the corresponding QoS flow (e.g., packet detection rules, etc.).

18b) [Conditional operation] Signaling from UPF to SMF: The UPF may transmit an N4 session modification response to the SMF.

19) [Conditional operation] Signaling from SMF to AMF: The SMF may transmit an Nsmf_PDUSession_UpdateSMContext response to the AMF.

20a) [Conditional operation] Signaling from SMF to new UPF (or I-UPF): The SMF may transmit an N4 session modification request to a new UPF (or I-UPF).

When the forwarding tunnel is established for the new I-UPF and when the timer set by the SMF for the forwarding tunnel in step 8a expires, the SMF may transmit an N4 session modification request to the new UPF (or I-UPF) operating as an N3 endpoint to release the forwarding tunnel.

20b) [Conditional operation] Signaling from new UPF (or I-UPF) to SMF: The new UPF (or I-UPF) may transmit an N4 session modification response to the SMF.

The new UPF (or I-UPF) operating as the N3 endpoint may transmit an N4 session modification response to the SMF.

21a) [Conditional operation] Signaling from SMF to UPF (PSA): The SMF may transmit an N4 session modification request to the UPF (PSA).

When the forwarding tunnel is established for the UPF (PSA) and when the timer set by the SMF for the forwarding tunnel in step 7b expires, the SMF may transmit an N4 session modification request to the UPF (PSA) operating as the N3 endpoint to release the forwarding tunnel.

21b) [Conditional operation] Signaling from UPF (PSA) to SMF: UPF (PSA) may transmit an N4 session modification response to the SMF.

UPF (PSA) operating as an N3 endpoint may transmit an N4 session modification response to the SMF.

22a) [Conditional operation] Signaling from SMF to previous UPF: The SMF may transmit an N4 session modification request or an N4 session release request to the previous UPF.

When the SMF determines to continue to use the previous UPF in step 5, the SMF may transmit the N4 session modification request to the previous UPF and provide AN tunnel information.

When the SMF selects a new UPF operating as an I-UPF in step 5 and the previous UPF is not a PSA UPF, the SMF may initiate resource release by transmitting an N4 session release request (including release cause) to the previous I-UPF after the timer in step 6b or 7b expires.

22b) Signaling from previous I-UPF to the SMF: The previous I-UPF may transmit an N4 session modification response or an N4 session release response to the SMF.

The previous UPF checks the modification or release of resources through a N4 session modification response or a N4 session release response.

An example of the UE initiated service request procedure is the same as steps 1 to 22b described above.

For mobility-related events, the AMF may invoke an Namf_EventExposure_Notify service operation after step 4.

When Namf_EventExposure_Notify is received with an indication that the UE is reachable, if the SMF has pending DL data, the SMF may invoke the Namf_Communication_N1N2MessageTransfer service operation for the AMF to establish a user plane for the PDU session. In other cases, the SMF may resume transmitting the DL data notification to the AMF in the case of DL data.

FIG. 12 is a signal flowchart illustrating an exemplary network initiated service request procedure.

The network initiated service request procedure is used when there is a need for activating a user plane for the PDU session to transfer signaling (e.g., N1 signaling to the UE, mobile-terminated short message service (SMS)), mobile terminating (a destination of data is UE) user data with the UE.

When the network initiated service request procedure is triggered by a short message service function (SMSF), PCF, location management function (LMF), gateway mobile location center (GMLC), NEF or UDM, the SMF in FIG. 12 may be replaced by a corresponding NF. For example, when the network initiated service request procedure is triggered by the PCF, the PCF may perform operations performed by the SMF of FIG. 12.

When the UE is in the CM-IDLE state or the CM-CONNECTED state in 3GPP access, the network initiates a network service request procedure.

When the UE is in the CM-IDLE state and asynchronous type communication is not activated, the network may transmit a paging request to the (R)AN/UE. The paging request triggers a UE initiated service request procedure in the UE. When asynchronous type communication is activated, the network stores the received message, and when the UE enters the CM-CONNECTED state, the network may transfer the received message to the (R)AN and/or the UE.

When the UE is in the CM-IDLE state in non-3GPP access and the UE is simultaneously registered for 3GPP access and non-3GPP access in one public land mobile network (PLMN), the network may initiate the network initiated service request procedure via 3GPP access.

When the UE is in the CM-IDLE state in 3GPP access, in the CM-CONNECTED state in non-3GPP access, and the UE is simultaneously registered for 3GPP access and non-3GPP access in one PLMN, the network may initiate the network initiated service request procedure through 3GPP access.

In the network initiated service request procedure, both SMF and UPF belong to a PLMN serving the UE. For example, in a home routed roaming case, the SMF and UPF of a HPLMN are not affected by a service request procedure (that is, the SMF and UPF of the HPLMN are not involved in the service request procedure).

The procedure of FIG. 12 deals with a non exhaustive list of use-cases for 3GPP access as follows (detailed conditions to which each step is applied are described in the procedure below):
When the SMF needs to set up an N3 tunnel in order to deliver a downlink packet for a PDU session to the UE and the UE is in the CM-IDLE state: Step 3a includes an N2 message and step 4b (paging) may be performed.
When the SMF needs to set up an N3 tunnel in order to deliver a downlink packet for a PDU session to the UE and the UE is in a CM-CONNECTED state: Step 3a includes an N2 message and step 4a (UP activation) may be performed.
If an NF (e.g., SMF, SMSF, LMF or NEF) needs to transmit an N1 message to the UE and the UE is in the CM-IDLE state: Step 3a includes an N1 message, step 3b includes a cause “Attempting to reach UE”, and step 4b (paging) occurs.
When the NF (e.g., SMSF, PCF, or UDM) triggers the AMF to set up a NAS connection with the UE and the UE is in the CM-IDLE state: Trigger differ according to procedures, step 4b (paging) is occurs.

1) When the UPF receives downlink data for the PDU session and AN tunnel information for the PDU session is not stored in the UPF, the UPF may buffer the downlink data or transfer the downlink data to the SMF based on an instruction received from the SMF.

2a) Signaling from the UPF to the SMF: The UPF may transmit a data notification to the SMF. The data notification may include an N4 session ID, information for identifying a QoS flow for a DL data packet, and DSCP.
When the first downlink data for a certain QoS flow arrives, if the SMF has not previously informed the UPF not to transmit a data notification to the SMF, the UPF may transmit a data notification message to the SMF. For reference, if the SMF previously informs the UPF not to transmit the data notification to the SMF, follow-up steps may be omitted.
When the UPF receives a downlink data packet for a different QoS flow in the same PDU session, the UPF may transmit another data notification message to the SMF.
When a paging policy differentiation feature is supported by the UPF and a PDU session type is IP, the UPF may include a DSCP of a TOS (Type of Service)(IPv4)/TC (Traffic Class)(IPv6) received from an IP header of the downlink data packet and information for identifying QoS flows for DL data packets in the data notification.

2b) Signaling from SMF to UPF: A data notification Ack may be transmitted.

2c) When the SMF instructs the UPF that it will buffer the data packet, the UPF may deliver the downlink data packet to the SMF.
When the paging policy differentiation feature is supported by the SMF, the SMF may determine a paging policy indication based on the DSCP of the TOS(IPv4)/TC(IPv6) value received from the IP header of the downlink data packet and identify a QFI of the QoS flow for the DL data packet.

3a) [Conditional operation] i) Signaling from SMF to AMF: The SMF may transmit a Namf_Communication_N1N2MessageTransfer (including SUPI, PDU session ID, N2 SM information (including QFI(s), QoS profile(s), CN N3 tunnel information, S-NSSAI, and paging policy indication), area of validity for N2 SM information, ARP (Allocation and Retention Priority) including paging policy indication, 5QI and N1N2TransferFailure notification target address) to the AMF. Or, ii) signaling from NF to AMF: NF may transmit Namf_Communication_N1N2MessageTransfer (including SUPI and N1 messages) to the AMF.

Upon receiving the data notification message, the SMF may perform an operation to support the LADN for a PDU session corresponding to the LADN. The SMF may notify the UPF that transmitted the data notification to discard downlink data for the PDU session and/or not to provide an additional data notification message.

In other cases, the SMF may determine whether to contact the AMF. The SMF may not contact the AMF in the following cases:
If the SMF previously notified that the UE is unreachable; or
If the UE is reachable only for a regulatory prioritized service and the PDU session is not a regulatory prioritized service.

The SMF determines the AMF, and the SMF may invoke Namf_Communication_N1N2MessageTransfer to the AMF by including the PDU session ID derived from the N4 session ID received in step 2a.

If the SMF receives any additional data notification message or downlink data packet while waiting for the user plane connection to be activated and if the SMF buffers a data packet for a QoS flow related to a priority (e.g., ARP priority level) higher than the priority related to the previous data notification message or downlink data packet, the SMF may invoke a new Namf_Communication_N1N2MessageTransfer indicating a higher priority ARP and PDU session ID to the AMF.

When the SMF receives a message from a new AMF (not the AMF to which the SMF previously called the Namf_Communication_N1N2MessageTransfer), while waiting for the user plane connection to be activated, the SMF may re-invoke Namf_Communication_N1N2MessageTransfer to the new AMF.

When supporting paging policy differentiation, the SMF may show a 5QI related to QFI of step 2a, packet received in step 2c, or a paging policy indication related to downlink data received from ARP or UPF or downlink data triggered a data notification message in the Namf_Communication_N1N2MessageTransfer.

NOTE 1: The AMF may receive a request message to perform signaling to the UE/RAN (e.g., network-initiated deregistration, SMF initiated PDU session modification, etc.) from other network functions (NFs). When the UE is in the CM-CONNECTED state and the AMF delivers only an N1 message to the UE, the flow continues in step 6 below.

N2 SM information is optional. For example, when the SMF intends to transmit a PDU session modification command only to update the UE to the PCO, N2 SM information may be optional.

3b) [Conditional operation] The AMF may respond to the SMF.

If the UE is in the CM-IDLE state for the AMF and the AMF may page the UE, the AMF may directly transmit a Namf_Communication_N1N2MessageTransfer response to the SMF with the cause “Attempting to reach UE”. The cause “Attempting to reach UE” may indicate to the SMF that the N2 SM information provided in step 3a may be ignored by the AMF if the UE is reachable and that the SMF is requested to provide the N2 SM information again.

While waiting for the UE to respond to the previous paging request, when the AMF receives a Namf_Communication_N1N2MessageTransfer request message having the same priority or lower priority as the previous message triggering paging or when the AMF determines not to trigger an additional paging request for the UE based on a local policy, the AMF may reject the Namf_Communication_N1N2MessageTransfer request message.

When the UE is in the CM-CONNECTED state in the AMF, the AMF may immediately transmit a Namf_Communication_N1N2MessageTransfer response to the SMF with a “N1/N2 transfer success” cause.

If the UE is in the CM-IDLE state and the AMF determines that the UE is not reachable for paging, the AMF may transmit a Namf_Communication_N1N2MessageTransfer response to the SMF or other network functions (NF transmitting the request message to the AMF in step 3a). Alternatively, the AMF may perform asynchronous type communication and store UE context based on the received message. When asynchronous type communication is invoked, when the UE is reachable (e.g., when the UE enters the CM-CONNECTED state), the AMF may initiate communication with the UE and the (R)AN.

When the AMF determines that the UE is not reachable for the SMF (e.g., as the UE is in a mobile initiated connection only (MICO) mode or the UE is registered only through non-3GPP access and the UE is in the CM-IDLE state), the AMF may reject the request from the SMF. When the SMF does not subscribe to a UE reachability event, the AMF may include an indication (indication that the SMF does not need to trigger a Namf_Communication_N1N2MessageTransfer request for the AMF) in the rejection message. The AMF may store the indication that the SMF has been informed that the UE is not reachable.

When the UE is not in the MICO mode and the AMF detects that the UE is in a non-allowed Area, the AMF may reject a request from the SMF and notify the SMF that the UE is reachable only for the regulatory prioritized service, unless the request from the SMF is for the regulation priority service. The AMF may store the indication that the SMF has been informed that the UE is only reachable for the regulatory prioritized service.

If a registration procedure with an AMF change is in progress when a previous AMF receives Namf_Communication_N1N2MessageTransfer, the previous AMF may reject the request with an indication that Namf_Communication_N1N2MessageTransfer has been temporarily rejected.

When a Namf_Communication_N1N2MessageTransfer response is received with the indication that the request has been temporarily rejected, the SMF may start a locally set guard timer and may wait until a random message comes from the AMF. When a message from the AMF is received, the SMF may re-call Namf_Communication_N1N2MessageTransfer (together with N2 SM information) to the AMF that transmitted the message. In other cases, the SMF may perform step 3a when the guard timer expires. If the SMF determines that control region buffering is applied, the SMF may request the UPF to start transmitting a downlink data PDU to the SMF.

3c) [Conditional operation] SMF may respond to UPF. For example, the SMF may transmit a failure indication to the UPF.

The SMF may notify the UPF of a user plane setup failure.

When the SMF receives an indication that the UE is not reachable or that the UE is reachable only for the regulation priority service from the AMF, the SMF may perform the following operation based on the network policy:
The SMF may instruct the UPF to stop sending data notifications;
The SMF may instruct the UPF to stop buffering the DL data and discard the buffered data;
The SMF may instruct the UPF to stop sending data notifications, stop buffering DL data, and discard the buffered data; or
While the UE is not reachable, the SMF suppresses transmitting an additional Namf_Communication_N1N2MessageTransfer message for DL data.

Based on the operator policy, the SMF may apply a suspension of the charging procedure.

When the SMF receives an indication from the AMF that the Namf_Communication_N1N2MessageTransfer requested by the SMF has been temporarily rejected, the SMF may instruct the UPF to apply temporary buffering based on the network policy.

4a) [Conditional operation] When the UE is in the CM-CONNECTED state in the access related to the PDU session ID received from the SMF in step 3a, steps 12 to 22 of FIGS. 11A to 11C may be performed without transmitting a paging message to the (R)AN node and the UE to activate the user plane connection for the PDU session (e.g., radio resources and N3 tunnels may be established). In step 12 of FIGS. 11A to 11C, the AMF may not transmit a NAS service acceptance message to the UE. Parts other than steps 12 to 22 of FIGS. 11A to 11C may be omitted.

4b) [Conditional operation] Even when the UE is in the CM-IDLE state in 3GPP access, the PDU session ID received from the SMF in step 3a is related to the 3GPP access, and the UE is in the CM-CONNECTED state for non-3GPP access, if the AMF determines to notify the UE through 3GPP access based on the local policy, the AMF may transmit a paging message to the NG-RAN node through 3GPP access.

When the UE is simultaneously registered through 3GPP access and non-3GPP access in the same PLMN, the UE is in the CM-IDLE state in 3GPP access and non-3GPP access mode, and the PDU session ID of step 3a is related to the non-3GPP access, the AMF may transmit a paging message related to the access “non-3GPP” to the NG-RAN node through 3GPP access.

When the UE is in RM (Registration Management)-REGISTERED state and CM-IDLE state and the UE is reachable in 3GPP access, the AMF may transmit a paging message (including NAS ID for paging, registration area list, paging DRX length, paging priority indication, and access associated to the PDU session) to the (R)AN node belonging to the registration area in which the UE is registered. When the paging message is received from the AMF, the NG-RAN node may page the UE by including access related to the PDU session in the paging message.

For reference, two RM states of an RM-DEREGISTERED state and an RM-REGISTERED state are used in the UE and the AMF to reflect the registration state of the UE in the PLMN.

When supporting paging policy differentiation, the paging strategy may be set in the AMF for different combinations of DNN, paging policy indication, ARP, and 5QI.

For the RRC-inactive state, a paging strategy may be set in (R)AN for other combinations of paging policy indication, ARP, and 5QI.

The paging priority indication may be included only in the following cases:
When the AMF receives a Namf_Communication_N1N2MessageTransfer message including an ARP value related to priority services (e.g., MPS, MCS) set by an operator.
One paging priority level may be used for multiple ARP values. Mapping of the ARP value for the paging priority level may be set in the AMF and NG-RAN according to an operator policy.

The (R)AN may prioritize paging of the UE according to the paging priority indication (or paging policy indicator).

While waiting for a response from the UE to the paging request message transmitted without a paging priority indication (or paging policy indicator), if the AMF receives a Namf_Communication_N1N2MessageTransfer message indicating an ARP value related to the priority service (e.g., MPS, MCS) set by the operator, the AMF may transmit another paging message together with an appropriate paging priority (or paging policy indicator). For the Namf_Communication_N1N2MessageTransfer message received later having the same priority or higher priority, the AMF may determine whether to transmit a paging message with an appropriate paging priority based on the local policy.

Paging strategies may include the following:
Paging retransmission scheme (e.g., how often paging is repeated or at what time interval paging is repeated);
Determine whether to transmit a paging message to the (R)AN node during specific AMF high load conditions;
Whether to apply sub-area-based paging (e.g., first paging in the last known cell-id or TA and retransmission in all registered TAs)

NOTE 2: Setting a paging priority (or paging policy indicator) in the paging message is independent of any paging strategy.

In order to reduce the signaling load and network resources used to successfully page the UE, the AMF and (R)AN may support additional paging optimization using at least one or more of the following means:
By the AMF implementing specific paging strategies (e.g., the AMF may send an N2 paging message to the (R)AN node that has recently served the UE);
By that AMF taking into account information (information on recommended cells and NG-RAN nodes) on recommended cells and NG-RAN nodes provided by (R)AN when switching to the CM-IDLE state. The AMF may determine the (R)AN node to be paged by considering the (R)AN node-related part of the information, include the information on the recommended cells in the N2 paging message, and provide the information to each of the (R)AN nodes;
By the (R)AN taking into account paging attempt count information provided by the AMF in paging.

When the UE radio capability for paging information is available in the AMF, the AMF may include the UE radio capability for paging information in the N2 paging message and transmit the corresponding N2 paging message to the (R)AN node.

When information on recommended cells and NG-RAN nodes are available in the AMF, the AMF may determine the (R)AN node for paging in consideration of the information, and when paging the (R)AN node, the AMF may transparently transmit the information on the recommended cell to the (R)AN node.

The AMF may include paging attempt count information in the N2 paging message. The paging attempt count information may be the same for all (R)ANs selected for paging by the AMF.

4c) [Conditional operation] When the UE is simultaneously registered for 3GPP access and non-3GPP access in the same PLMN, the UE is in the CM-CONNECTED state in 3GPP access, and the PDU session ID of step 3a is associated with the non-3GPP access, the AMF may transmit a NAS notification message including a non-3GPP access type to the UE through 3GPP access and may set a notification timer. When step 4c is performed, step 5 may be omitted.

When the UE is simultaneously registered for 3GPP access and non-3GPP access in the same PLMN, the UE is in the CM-IDL state in 3GPP access and in the CM-CONNECTED state in non-3GPP access, the PDU session ID of step 3a is associated with 3GPP access, and the AMF determines to notify the UE through the non-3GPP access based on the local policy, the AMF may transmit a NAS notification message including the 3GPP access type to the UE through the non-3GPP access and set a notification timer.

5) [Conditional operation] Signaling from AMF to SMF: The AMF may transmit a notification related to failure of Namf_Communication_N1N2Transfer to the SMF. For example, the AMF may transmit a Namf_Communication_N1N2TransferFailure notification to the SMF.

The AMF oversees the paging procedure using a timer. If the AMF fails to receive a response with respect to the paging request message from the UE, the AMF may apply additional paging according to any available paging strategy described in step 4b.

If the UE does not respond to the paging, the AMF sends a Namf_Communications_N1N2MessageTransfer Failure notification to a notification target address provided by the SMF in step 3a to the SMF to notify the SMF unless the AMF recognizes an ongoing MM procedure that prevents the UE from responding to the SMF. Here, the AMF recognizes the ongoing MM procedure that prevents the UE from responding may be a case in which, for example, the AMF receives an N14 context request message indicating that the UE performs a registration procedure with another AMF.

When the Namf_Communication_N1N2TransferFailure notification is received, the SMF may notify the UPF.

6) When the UE is in the CM-IDLE state in 3GPP access and a paging request for a PDU session related to 3GPP access is received, the UE may initiate the UE initiated service request procedure described in FIGS. 11A to 11C. In step 4 of FIG. 11A, the AMF may call a Nsmf_PDUSession_UpdateSMContext request associated with a PDU session identified in the service request message (excluding the PDU session for the PDU session ID included in Namf_Communication_N1N2MessageTransfer in step 3a of FIG. 12) to the SMF. To support the transfer of buffered data, the SMF may instruct the UPF to establish a data transfer tunnel between the old UPF and the new UPF or PSA as described in steps 6a, 7a, and 8b of FIG. 11A.

When the UE is in the CM-IDLE state in both non-3GPP access and 3GPP access and receives a paging request for a PDU session associated with non-3GPP access, the UE may initiate the UE initiated service request procedure described in FIGS. 11A to 11C. Here, the UE initiated service request procedure may include a list of allowed PDU sessions that may be re-activated through 3GPP access according to the UE policy and whether an S-NSSAI of the PDU session is included in the allowed NSSAI for 3GPP access. If there is no PDU session that may be re-activated through 3GPP access, the UE may include a list of empty allowed PDU sessions. When the AMF receives a service request message from the UE through the non-3GPP access (e.g., due to the UE successfully connecting to the non-3GPP access), the AMF may stop the paging procedure and process the received service request procedure. When the AMF receives the service request message and the list of allowed PDU sessions provided by the UE does not include the PDU session for the UE that has been paged, the AMF may invoke the Namf_EventExposure_Notify service to notify the SMF that the UE is reachable but did not accept re-activation of the PDU session.

When the UE is in the CM-IDLE state in non-3GPP access and in the CM-CONNECTED state in 3GPP access, upon receiving the NAS notification message including the non-3GPP access type through 3GPP access, the UE may initiate UE initiated service request procedure described in FIGS. 11A to 11C. Here, the UE initiated service request procedure may include a list of allowed PDU sessions that may be re-activated through 3GPP access according to the UE policy and whether the S-NSSAI of this PDU session is included in the allowed NSSAI for 3GPP access. If there is no PDU session that may be re-activated through 3GPP access, the UE may include a list of empty allowed PDU sessions. When the AMF receives the service request message and the list of the allowed PDU sessions provided by the UE does not include a PDU session for the UE that has been notified, the AMF may call the Namf_EventExposure_Notify service to notify the SMF that the UE is reachable but did not accept re-activation of the PDU session. When the AMF receives the service request message from the UE through non-3GPP access, the AMF may stop the notification timer and process the received service request procedure.

When the UE is in the CM-IDLE state in 3GPP access and in the CM-CONNECTED state in non-3GPP access, upon receiving the NAS notification identifying the 3GPP access type through the non-3GPP access, the UE may initiate the UE initiated service request procedure described in FIGS. 11A to 11C through 3GPP access if the 3GPP access is available. If the AMF does not receive the service request message before the notification timer expires, the AMF may page the UE through 3GPP access or notify the SMF that the UE was unable to re-activate the PDU session.

7) The UPF may transmit buffered downlink data to the UE through the (R)AN node that has performed the service request procedure.

The network may transmit downlink signaling when a network initiated service request procedure is initiated according to a request from another network described in step 3a.

2. Disclosure of this Specification

When a terminal (a (wireless) communication device including a user equipment (UE)) is in an Idle state in 3GPP access, if DL (downlink) data to be transmitted to the UE arrives, the AMF should perform a paging procedure. That is, the AMF needs to transmit a paging message to the UE.

In this case, the UE performs an operation of periodically checking the paging message transmitted from the AMF at a specific time by performing a discontinuous reception (DRX) operation. Upon reading (receiving) the paging message, the UE performs a service request (SR) procedure as a response for the paging message if the corresponding paging message is a paging message for itself.

In this process, the response of the UE for the paging message (i.e., performing the SR procedure) may be delayed according to a configuration of the DRX cycle. If the UE cannot receive the paging message due to poor communication conditions such as a radio condition, the AMF may retransmit the paging message to the UE according to the operator policy. When the AMF retransmits the paging message to the UE, a time may be further delayed until the UE performs the SR procedure.

In 5G NR, when the UE is provided with a low latency service (e.g., a URLLC-related service), a delay time caused as the UE does not receive a paging message or as the AMF retransmits the paging message may affect end-to-end services. Due to the delay time, there is a problem that the UE may not be provided with a low delay service. Accordingly, there is a need for a method for rapidly providing a low-delay service to a UE by reducing the delay time.

In the present disclosure, a method for efficiently setting up a user plane of a PDU session for a low latency service in a situation in which the UE is simultaneously connected to a network through 3GPP access and non-3GPP access in the 5G system. According to the present disclosure, the delay time described above is reduced, so that a low delay service may be quickly provided to the UE.

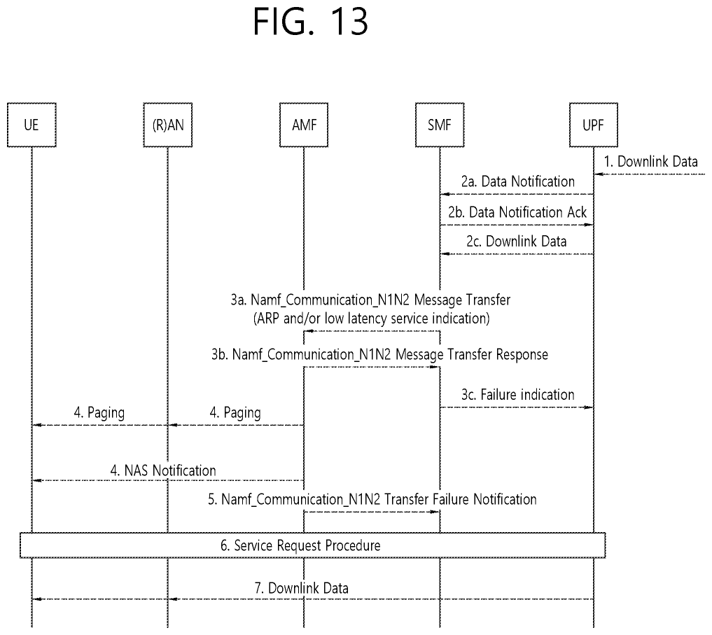

Hereinafter, the present disclosure will be described with reference to FIGS. 13 to 15.

FIG. 13 is a signal flowchart illustrating an example of a scheme according to the present disclosure.

Hereinafter, descriptions of the same contents as those of FIG. 12 are omitted and FIG. 13 will be described focusing on differences from FIG. 12. In FIG. 13, each of the UE, (R)AN, AMF, SMF, and UPF may perform all the operations described in FIG. 12.

In the present disclosure, it is assumed that the UE is connected with both 3GPP access and non-3GPP access (e.g., Wi-Fi access). And, it is assumed that both 3GPP access and non-3GPP access to which the UE is connected are managed by one AMF.

In general, a UE requiring a low-latency service establishes (i.e., creates) a PDU session through 3GPP access to receive a service. That is, for example, a situation in which a PDU session related to a specific service (e.g., low-latency service) is established (established through at least one of 3GPP access or non-3GPP access) in the same manner as the example described in FIGS. 10A and 10B is assumed. That is, it is assumed that the SMF transmits a PDU session establishment acceptance message to the UE before operations of each device according to the example of FIG. 13 are performed.

In addition, in the present disclosure, when the UE uses a low-delay service (when a PDU session related to the low-delay service is used), if the UE has available non-3GPP access, the UE performs a registration procedure even through the non-3GPP access. In this case, the UE may perform the registration procedure in the same PLMN or equivalent PLMN (EPLMN) as the 3GPP access to which the UE is connected, so that the UE may be managed by the same AMF.

When establishing a PDU session, the AMF may know that the PDU session is a PDU session related to a low-latency service based on information related to the PDU session. Here, the information related to the PDU session may be received by the AMF from the UE. Alternatively, the information related to the PDU session may be received by the AMF from another network node such as an SMF or a UPF. The information related to the PDU session may include at least one of a PDU session ID, a DNN, an S-NSSAI, information on a characteristic of a UE, information on a capability of a UE, and the like. The AMF may recognize that the corresponding PDU session is a PDU session related to a low-latency service based on information related to the PDU session.

After the UE establishes a PDU session related to the low-delay service (i.e., the low-delay service PDU session), if the UE does not transmit or receive data for a certain period of time, the UE may enter an Idle state (e.g., CM-IDLE state). That is, the UE may enter the Idle state in 3GPP access in which the corresponding PDU session is established. The AMF may recognize whether the UE is in a connected state or an idle state by managing the CM-state of the UE.

1) After the UE enters the Idle state, the UPF may receive downlink (DL) data to be transmitted to the UE. The description of step 1 of FIG. 12 may be equally applied.

2a) Then, the UPF may transmit a data notification message indicating that the downlink data has been received to the SMF. The description of step 2a of FIG. 12 may be equally applied.

2b) The SMF may transmit a data notification Ack to the UPF.

2c) When the SMF indicates to the UPF that it will buffer the data packet, the UPF may deliver a downlink data packet to the SMF. The description of step 2c of FIG. 12 may be equally applied.

3a) The SMF transmits a message related to downlink data to be transmitted to the UE to the AMF. For example, the SMF transmits a request (e.g., Namf_Communication_N1N2MessageTransfer) to perform a user plane setup to the AMF. In this case, the SMF may send implicit or explicit information (or indication) notifying that the corresponding request is related to the low-latency service to the AMF.

After step 3a, the AMF may determine whether a message (e.g., a request to perform user plane setup) received from the SMF is related to a specific service (e.g., a low-latency service). That is, the AMF may determine whether downlink data to be transmitted to the UE is related to a specific service (e.g., low-latency service). Specifically, the AMF may determine whether the message received from the SMF is related to the low-latency service based on at least one of the following three exemplary operations.

i) Operation 1: When the SMF requests Namf_Communication_N1N2MessageTransfer service to the AMF (that is, when the SMF transmits a message related to downlink data to the AMF), if the service is a high priority service (e.g., multimedia priority service (MPS) and modulation coding scheme (MCS)), the SMF may transmit the ARP together. Even when the downlink data is related to the low-delay service, the SMF may transmit the ARP together with Namf_Communication_N1N2MessageTransfer or may include the ARP in the Namf_Communication_N1N2MessageTransfer and transmit the same to the AMF. When the AMF receives the ARP from the SMF, the AMF may recognize that the corresponding request is related to the low latency service. That is, if the message (e.g., Namf_Communication_N1N2MessageTransfer) received from the SMF includes the ARP set to be used for a low-delay service by the operator, the AMF may recognize that the message is for a low-delay service.

ii) Operation 2: When the SMF transmits a message for downlink data to be transmitted to the UE to the AMF, the SMF may transmit information indicating that the message is related to the low-latency service together. For example, while the SMF requests the Namf_Communication_N1N2MessageTransfer service to the AMF, the SMF may directly add a low-delay service indication (i.e., information indicating that the request is for a low-delay service). When the AMF receives the low-delay service indication, the AMF may know that the message received from the SMF is related to the low-delay service. In this case, the SMF may also transmit ARP together to the AMF to support paging policy differentiation for low-latency services. For example, when the same UE establishes a plurality of low-latency service-related PDU sessions, the AMF may transmit a paging message to the UE by applying a different page policy based on the ARP received from the SMF.

iii) Operation 3: The AMF may determine whether a message received from the SMF is related to a low-latency service based on the information stored in the AMF. Specifically, the information stored by the AMF may include at least one of a PDU session ID, a DNN, an S-NSSAI, information on a characteristic of a UE, information on a capability of a UE, and the like. For example, the PDU session ID related to a low-delay service, DNN related to a low-delay service, S-NSSAI related to a low-delay service, information on the characteristics of UE related to a low-delay service, or capability of UE related to a low-delay service may be stored in the AMF. Specifically, the AMF may determine whether a message received from the SMF is related to a low-latency service based on information included in a message received from the SMF and information stored in the AMF. For example, the AMF may find out information on DNN or information on S-NSSAI through the PDU session ID included in the Namf_Communication_N1N2MessageTransfer service. In addition, the AMF may recognize that the message received from the SMF is related to the low-latency service based on the PDU session ID, the information on the DNN or the information on the S-NSSAI and the information stored in the AMF. Alternatively, the AMF may recognize that the UE to receive downlink data is a UE receiving a low-latency service based on the information on the characteristics of the UE or the information on the capability of the UE. That is, the AMF may recognize that the message received from the SMF is related to the low-delay service by recognizing that the corresponding UE is a UE receiving a low-delay service.

3b) The AMF may respond to the SMF. For example, the AMF may transmit a Namf_Communication_N1N2MessageTransfer response to the SMF. The description of step 3b of FIG. 12 may be equally applied.

4) When the AMF recognizes that a message received from the SMF is related to a low-delay service according to at least one of the aforementioned operations 1 to 3 (e.g., when the AMF recognizes that a message received from the SMF is related to data notification on a PDU session related to a low-delay service), the AMF may perform paging via 3GPP access, while simultaneously transmitting NAS notification (with 3GPP indication and/or low-latency service indication) via non-3GPP access. That is, the AMF may transmit a paging message to the UE through 3GPP access, and transmit a NAS notification message to the UE through non-3GPP access. Here, the UE is in a state registered for both 3GPP access and non-3GPP access. In addition, the UE may be in an idle state for 3GPP access and a connected state for non-3GPP access.

The reason why the AMF transmits the NAS notification message to the UE through the non-3GPP access is because the UE is considered to be in a CM-CONNECTED state in the non-3GPP access. In other words, the UE is considered to be in the CM-CONNECTED state in non-3GPP access, and the AMF may transmit a NAS notification message to the UE through the non-3GPP access.

The AMF may set paging priority to be high, while transmitting the paging message to the UE through the RAN so that paging is performed quickly.

Even if the message received from the SMF is related to the first service (e.g., low-delay service), if communication through 3GPP access is difficult (e.g., paging was performed due to data for a general PDU session, but the UE did not respond so that the AMF recognized that the UE is unreachable), the AMF may transmit only a NAS notification message through non-3GPP access, or if communication for non-3GPP access is difficult (e.g., when the UE is in the CM-IDLE state in non-3GPP access), the AMF may transmit only a paging message through 3GPP access.

The description of step 12b of FIG. 12 may be equally applied to the operation regarding the transmission of the paging message, and the description of step 12b of FIG. 12 may be equally applied to the operation regarding the NAS notification.

5) When the AMF fails to receive a response on the paging message or a response on the NAS notification, the AMF may transmit a notification related to the failure of Namf_Communication_N1N2Transfer to the SMF. For example, the AMF may transmit a Namf_Communication_N1N2TransferFailure notification to the SMF. The description of step 5 of FIG. 12 may be equally applied.

6) When the UE receives either a paging message or a NAS notification message, the UE may immediately perform a service request procedure through 3GPP access. That is, the UE may transmit a service request message to the AMF through 3GPP access. The AMF transmits the paging message and the NAS notification message to the UE through 3GPP access and non-3GPP access, respectively, so that the UE may quickly switch to the connected state. That is, the UE may quickly switch to the connected state for the PDU session related to the low-latency service. The description of step 6 of FIG. 12 may be equally applied.

When the AMF receives the service request message from the UE, the AMF may stop the paging procedure and stop the NAS notification related timer (a timer for retransmitting the NAS notification message).

If the UE fails to perform the service request procedure through 3GPP access (e.g., out of 3GPP coverage, radio link failure (RLF), etc.), the UE may perform handover from 3GPP access to non-3GPP access for a PDU session related to low-delay service.

As an example, to this end, the UE should be able to recognize that the NAS notification message that the UE itself has received is related to the low-latency service. In order for the UE to recognize that the NAS notification message is related to the low-delay service, the AMF may additionally transmit information indicating that the NAS notification message is related to the low-delay service (low-delay service indication) (3GPP indication may be transmitted together or the 3GPP indication may be omitted). Alternatively, the AMF may omit the 3GPP indication and transmit only the low-latency service indication to the UE.

As another example, when the UE fails to perform a service request procedure through 3GPP access, if the UE has a low-latency service-related PDU session, the UE may unconditionally perform handover even if the low-latency service indication is not included in the NAS notification message. That is, the UE may perform handover from 3GPP access to non-3GPP access for a PDU session related to a low-delay service.

Meanwhile, in the step of performing the service request procedure (step 6), the AMF may receive information on the PDU session requesting activation from the UE. In this case, if there are a plurality of PDU sessions for which the UE has requested activation, among them, a PDU session related to a low-delay service may be included. Then, the AMF may not transmit a service acceptance message to the UE after waiting for receiving an activation result for all PDU sessions from the SMF and then as in the related art operation, but wait for only an activation result for the PDU session related to the low-latency service and then transmits the service acceptance message to the UE.

In other words, according to the conventional operation, when the AMF accepts a service request message for a plurality of PDU sessions from the UE, the AMF should wait for the activation result for all PDU sessions and then transmit the activation acceptance message to the UE. However, in the present disclosure, when the activation result for a PDU session related to a low-delay service is received, the AMF may preferentially transmit an activation acceptance message to the UE.

In this manner, since the UE does not have to wait for an activation result for a PDU session other than the PDU session related to the low-delay service, the UE may start the low-delay service earlier.

In this case, when there are a plurality of PDU sessions related to the low-delay service, the AMF may wait for all activation results for the PDU sessions related to the plurality of low-delay services and transmit an activation acceptance message to the UE. Alternatively, when certain conditions are satisfied, for example, when the AMF receives an activation result for the PDU sessions of a pre-configured minimum number (e.g., 1, 2, 3, etc.), among PDU sessions related to the low-latency service or when the AMF receives an activation result for a session mapped to a specific ARP among DPU sessions related to a low-delay service, the AMF may transmit an activation acceptance message to the UE.

For reference, the AMF may configure a cause value of the activation result (result of the activation request) for other PDU sessions (PDU sessions other than the PDU session related to the delayed service) to a pre-configured value (e.g., waiting for activation result, etc.). In addition, the AMF may transmit the cause value of the activation result for other PDU sessions to the UE. Through this, the AMF may inform the UE that the AMF is waiting for the activation result for a PDU session other than the PDU session related to the low-delay service.

Thereafter, the AMF may provide information on successfully activated PDU sessions or rejected PDU sessions in a NAS message and transmit the NAS message to the UE to inform the activated PDU sessions or rejected PDU sessions. Alternatively, since the UE may determine a successfully activated PDU session based on the resources set up in an access stratum (AS) layer, the AMF may include only information on the PDU sessions for which PDU session activation was rejected in the NAS message and transmit the message to the UE.

7) When the service request procedure is successfully performed, the UE may receive downlink data related to the low-delay service. Specifically, the UPF may transmit buffered downlink data to the UE through the (R)AN node that has performed the service request procedure.

For reference, in FIG. 13, the present disclosure has been described with the case of a low-delay service as an example. However, in addition to the low latency service, even when a specific service (e.g., eMBB service) to which the present disclosure is to be applied is designated according to a network, operator, or user setting, the operations described in FIG. 13 may be applied to the designated specific service.

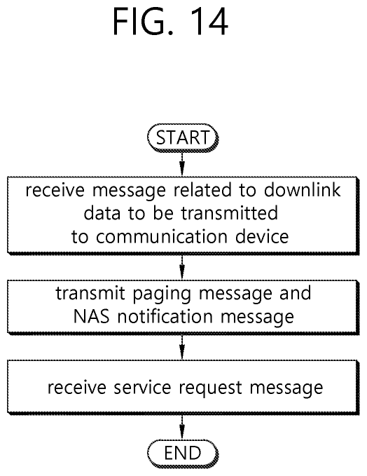

FIG. 14 is a signal flowchart illustrating an example of an operation of a network node according to the present disclosure.

FIG. 14 shows an example of an operation that may be performed by a network node, and the network node may perform the operation described above with reference to FIG. 13 even if it is not shown in FIG. 14.

The second network node (e.g., SMF) may transmit a first message including information indicating that the establishment of a PDU session associated with the first service (e.g., low-latency service) is accepted to the communication device (e.g., UE). That is, the PDU session related to the first service is established. The first network node (e.g., AMF) may receive information indicating that the establishment of the PDU session associated with the first service is accepted from the second network node, and transmit the received information to the communication device.

The first network node may receive a second message related to downlink data to be transmitted to the communication device from the second network node (e.g., SMF). For example, the second message may be Namf_Communication_N1N2MessageTransfer. Here, the second message may include an ARP value. Alternatively, the second message may further include first information indicating that the second message is related to the first service (e.g., low latency service indication of operation 2 described in FIG. 13). The second message may include a PDU session ID associated with downlink data.

Although not shown in FIG. 14, after receiving the second message, the first network node may further perform determining whether the second message is related to the first service. When the ARP value is included in the second message, the first network node may determine whether the second message is related to the first service based on the included ARP value. When the first information is included in the second message, the first network node may determine whether the second message is related to the first service based on the first information. The first network node may determine whether the second message is related to the first service based on the second information stored in the first network node. Here, the second information stored in the first network node may include at least one of a PDU session ID related to the first service, a DNN related to the first service, S-NSSAI related to the first service, or UE capability information related to the first service. When the PDU session ID is included in the second message, the first network node may determine whether the second message is related to the first service based on the PDU session ID included in the second message and the second information.

The first network node may transmit a paging message and a NAS notification message to the communication device. Specifically, when the second message is related to the first service and the communication device is in an idle state for 3GPP access, the first network node may transmit the paging message and the NAS notification message to the communication device. Here, the paging message may be transmitted to the communication device through 3GPP access, and the NAS notification message may be transmitted to the communication device through non-3GPP access. Here, the communication device may be in a connected state for non-3GPP access.

The first network node may receive a service request message from the communication device. Specifically, the first network node may receive a service request message for downlink data through 3GPP access.

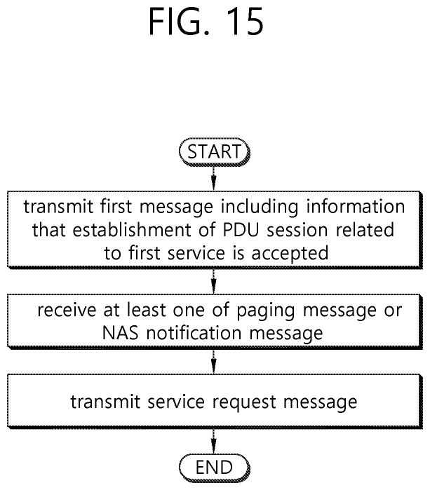

FIG. 15 is a signal flowchart illustrating an example of an operation of a communication device according to the present disclosure.

FIG. 15 shows an example of an operation that may be performed by the communication device, and the communication device may perform the operations described above with reference to FIG. 13, even if not illustrated in FIG. 14.

The communication device may be in an idle state for 3GPP access and a connected state for non-3GPP access. The communication device may be an autonomous driving device that communicates with at least one of a mobile terminal, a network, and an autonomous vehicle other than the communication device itself.

The communication device may receive, from a second network node, a first message including information indicating that establishment of a PDU session associated with a first service (e.g., low-latency service) is accepted. That is, a PDU session related to the first service is established.

The communication device may receive at least one of a paging message related to downlink data or a NAS communication message related to downlink data from the first network node. Here, the first network node transmits both the paging message and the NAS notification message, but the communication device may receive only one or both messages according to a network state or an arrival speed of the message. Here, the downlink data is data related to the first service. The paging message may be transmitted to the communication device through 3GPP access, and the NAS notification message may be transmitted to the communication device through non-3GPP access.

The communication device may transmit a service request message for downlink data to the first network node. The service request message may be transmitted through 3GPP access.

Although not shown in FIG. 15, when transmission of the service request message through 3GPP access fails, the communication device may perform handing over a PDU session associated with the first service from the 3GPP access to the non-3GPP access.

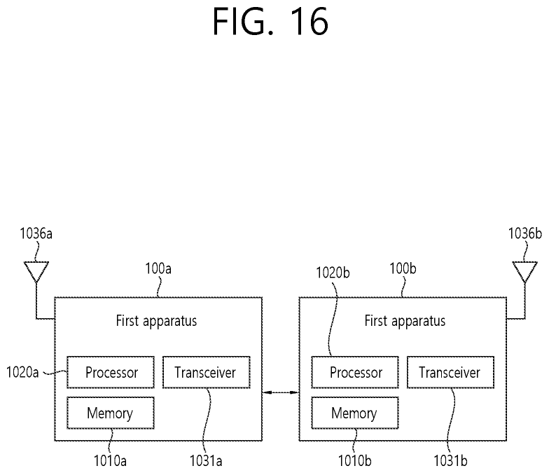

FIG. 16 shows a wireless communication device according to the present disclosure.

Referring to FIG. 16, a wireless communication system may include a first apparatus 100a and a second apparatus 100b.

The first apparatus 100a may be a base station, a network node, a transmission terminal, a reception terminal, a wireless apparatus, a wireless communication apparatus, a vehicle, a vehicle mounted with an automatic driving function, a Connected Car, a drone (Unmanned Aerial Vehicle, UAV), an AI (Artificial Intelligence) module, a robot, an AR (Augmented Reality) apparatus, a VR (Virtual Reality) apparatus, an MR (Mixed Reality) apparatus, a hologram apparatus, a public safety apparatus, an MTC apparatus, an IoT apparatus, a medical apparatus, a pin tech apparatus (or financial apparatus), a security apparatus, a climate/environment apparatus, an apparatus related to 5G service, or another apparatus related to the Fourth Industrial Revolution field.

The second apparatus 100b may be a base station, a network node, a transmission terminal, a reception terminal, a wireless apparatus, a wireless communication apparatus, a vehicle, a vehicle mounted with an automatic driving function, a Connected Car, a drone (Unmanned Aerial Vehicle, UAV), an AI (Artificial Intelligence) module, a robot, an AR (Augmented Reality) apparatus, a VR (Virtual Reality) apparatus, an MR (Mixed Reality) apparatus, a hologram apparatus, a public safety apparatus, an MTC apparatus, an IoT apparatus, a medical apparatus, a pin tech apparatus (or financial apparatus), a security apparatus, a climate/environment apparatus, an apparatus related to 5G service, or another apparatus related to the Fourth Industrial Revolution field.

The first apparatus 100a may include at least one memory like a processor 1020a, at least one memory like a memory 1010a and at least one transceiver like a transceiver 1031a. The processor 1020a may perform the above-described function, process and/or methods. The processor 1020a may perform one or more protocols. For example, the processor 1020a may perform one or more layers of a wireless interface protocol. The memory 1010a may be connected to the processor 1020a and store various types of information and/or commands. The transceiver 1031a may be connected to the processor 1020a and may be controlled to transmit and receive a radio signal.

The second apparatus 100b may include at least one memory like a processor 1020b, at least one memory like a memory 1010b and at least one transceiver like a transceiver 1031b. The processor 1020b may perform the above-described function, process, and/or methods. The processor 1020b may perform one or more protocols. For example, the processor 1020b may perform one or more layers of a wireless interface protocol. The memory 1010b may be connected to the processor 1020b and store various types of information and/or commands. The transceiver 1031b may be connected to the processor 1020b and may be controlled to transmit and receive a radio signal.

The memory 1010a and/or the memory 1010b may be connected to an interior or an exterior of the processor 1020a and/or the processor 1020b, respectively, and may also be connected to other processor through various techniques such as a wired or wireless connection.

The first apparatus 100a and/or the second apparatus 100b may have one or more antennas. For example, an antenna 1036a and/or an antenna 1036b may be configured to transmit or receive a radio signal

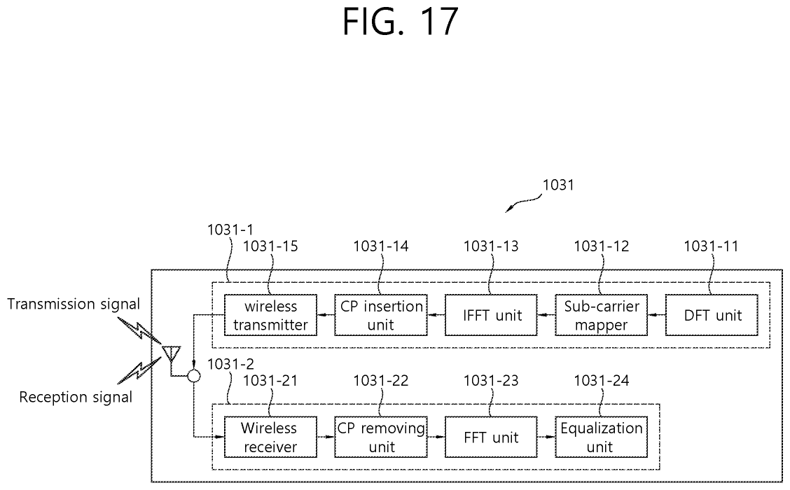

FIG. 17 is a detailed block diagram of the transceiver of the wireless communication device of FIG. 16.

In FIG. 17, a transceiver 1031 includes a transmitter 1031-1 and a receiver 1031-2. The transmitter 1031-1 includes a discrete Fourier transform (DFT) unit 1031-11, a subcarrier mapper 1031-12, an IFFT unit 1031-13, a CP insertion unit 1031-14, and a wireless transmission unit 1031-15. The transmitter 1031-1 may further include a modulator. In addition, the transmitter 1031-1 may further include, for example, a scramble unit (not shown), a modulation mapper (not shown), a layer mapper (not shown), and a layer permutator (not shown), and these elements may be disposed before the DFT unit 1031-11. That is, in order to prevent an increase in a peak-to-average power ratio (PAPR), the transmitter 1031-1 allows information to first pass through the DFT 1031-11, before mapping a signal to a subcarrier. A signal spread (or precoded) by the DFT unit 1031-11 may be subcarrier-mapped through the subcarrier mapper 1031-12 and subsequently pass through the IFFT unit 1031-13 so as to be made as a signal on a time axis.

The DFT unit 1031-11 performs DFT on input symbols and outputs complex-valued symbols. For example, when Ntx symbols are input (e.g., Ntx is a natural number), a DFT size is Ntx. The DFT unit 1031-11 may be called a transform precoder. The sub-carrier mapper 1031-12 maps the complex-valued symbols to respective sub-carriers on a frequency domain. The complex-valued symbols may be mapped to resource elements that correspond to a resource block allocated for a data transmission. The sub-carrier mapper 1031-12 may be called a resource element mapper. The IFFT unit 1031-13 performs IFFT for an input symbol and outputs a baseband signal for data, which is a time domain signal. The CP insertion unit 1031-14 copies a part of rear part of a baseband signal for data and inserts it in a front part of a baseband signal for data. Through the CP insertion, inter-symbol interference (ISI) and Inter-Carrier Interference (ICI) are prevented, and orthogonality may be maintained even in a multi-pass channel.

Meanwhile, the receiver 1031-2 includes a wireless receiver 1031-21, a CP removing unit 1031-22, an FFT unit 1031-23 and an equalization unit 1031-23. The wireless receiver 1031-21, the CP removing unit 1031-22 and the FFT unit 1031-23 perform inverse functions of the wireless transmitter 1031-15, the CP insertion unit 1031-14 and the IFFT unit 1031-13. The receiver 1031-2 may further include a demodulator

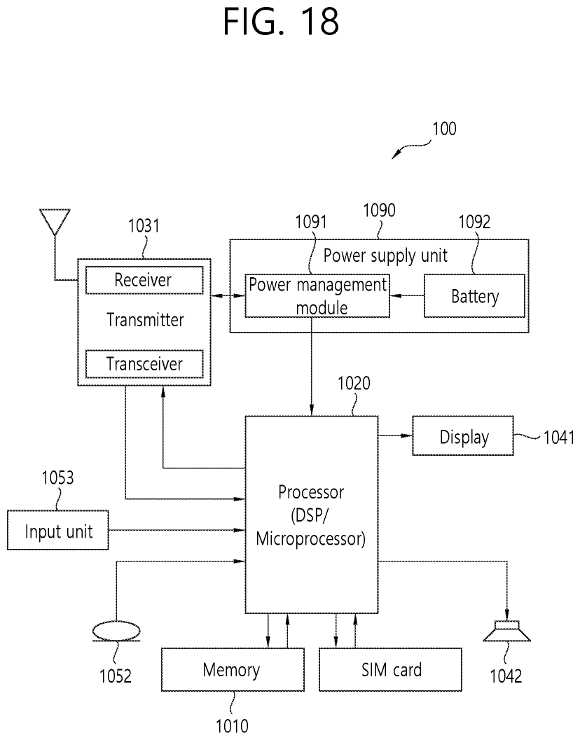

FIG. 18 is a detailed block diagram of the wireless communication device of FIG. 16.

FIG. 18 shows a more detailed wireless communication device implementing an embodiment of the present disclosure. The present disclosure described above for the wireless communication device side may be applied to this embodiment.

A wireless communication device includes a memory 1010, a processor 1020, a transceiver 1031, a power management module 1091, a battery 1092, a display 1041, an input unit 1053, a speaker 1042, a microphone 1052, a subscriber identification module (SIM) card, and one or more antennas.

The processor 1020 may be configured to implement the proposed function, process and/or method described in the present disclosure. Layers of a wireless interface protocol may be implemented in the processor 1020. The processor 1020 may include application-specific integrated circuit (ASIC), other chipset, logical circuit and/or data processing apparatus. The processor 1020 may be an application processor (AP). The processor 1020 may include at least one of a digital signal processor (DSP), a central processing unit (CPU), a graphics processing unit (GPU) and a modulator and demodulator (Modem). An example of the processor 1020 may be SNAPDRAGON™ series processor manufactured by Qualcomm®, EXYNOS™ series processor manufactured by Samsung®, A series processor manufactured by Apple®, HELIO™ series processor manufactured by MediaTek®, ATOM™ series processor manufactured by INTEL®, or the corresponding next generation processor.

The power management module 1091 manages a power for the processor 1020 and/or the transceiver 1031. The battery 1092 supplies power to the power management module 1091. The display 1041 outputs the result processed by the processor 1020. The input unit 1053 receives an input to be used by the processor 1020. The input unit 1053 may be displayed on the display 1041. The SIM card is an integrated circuit used to safely store international mobile subscriber identity (IMSI) used for identifying a subscriber in a mobile telephoning apparatus such as a mobile phone and a computer and the related key. Many types of contact address information may be stored in the SIM card.

The memory 1010 is operably coupled with the processor 1020 and stores various types of information to operate the processor 1020. The memory may include read-only memory (ROM), random access memory (RAM), flash memory, a memory card, a storage medium, and/or other storage device. When the embodiment is implemented in software, the techniques described in the present disclosure may be implemented in a module (e.g., process, function, etc.) for performing the function described in the present disclosure. A module may be stored in the memory 1010 and executed by the processor 1020. The memory may be implemented inside of the processor 1020. Alternatively, the memory 1010 may be implemented outside of the processor 1020 and may be connected to the processor 1020 in communicative connection through various means which is well-known in the art.

The transceiver 1031 is operably connected to the processor 1020 and transmits and/or receives a radio signal. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives a sound related input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 such that a user identifies it or for convenience.

According to the present disclosure, a network node (e.g., AMF) transmits a paging message to the UE through 3GPP access and transmits a NAS notification message through non-3GPP access, thereby allowing the UE to be provided with a low-latency service quickly and efficiently. Specifically, when information on the presence of downlink data is provided to the UE through two types of access, the UE may transmit a service request message even if only one of the paging message or the NAS notification message is received, so that a delay time required for transmitting the service request message may be reduced.

II. Scenarios to which the Disclosure of the Present Disclosure is Applicable

Hereinafter, scenarios to which the disclosure of the present disclosure is applicable are described.

In the present disclosure, an always-on PDU session for URLLC having a low-latency characteristic may be used for artificial intelligence, robots, autonomous driving, extended reality, and the like among the 5G scenarios below.

<5G Use Scenarios>

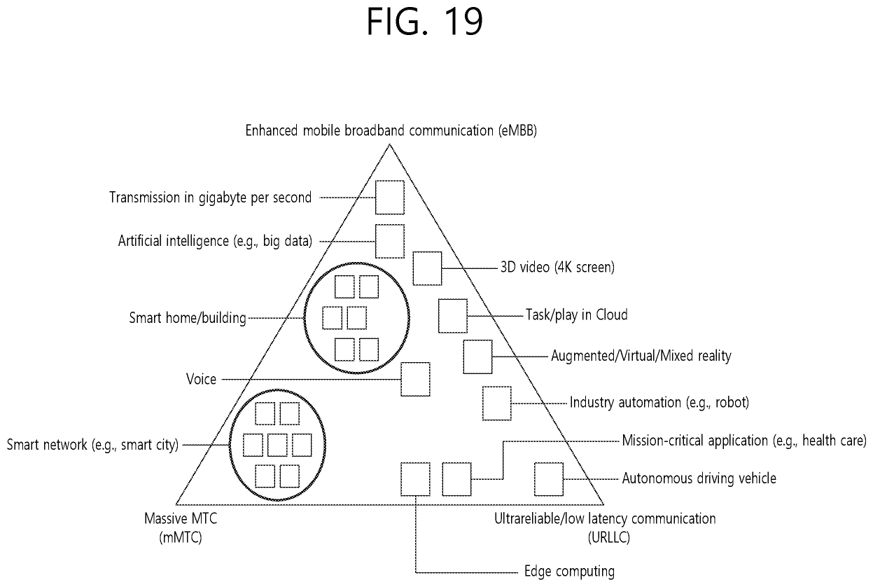

FIG. 19 illustrates an example of 5G use scenarios.

The 5G usage scenarios illustrated in FIG. 19 are merely exemplary, and the technical features of the present disclosure may also be applied to other 5G usage scenarios that are not illustrated in FIG. 19.

Referring to FIG. 19, three major requirement areas of 5G include: (1) an enhanced mobile broadband (eMBB) area, (2) a massive machine type communication (mMTC) area, and (3) an ultra-reliable and low latency communications (URLLC) area. Some examples of usage may require multiple areas for optimization, while other examples of usage may focus only on one key performance indicator (KPI). The 5G supports these various examples of usage in a flexible and reliable way.

The eMBB focuses generally on improvements in data rate, latency, user density, and capacity and coverage of mobile broadband access. The eMBB aims at a throughput of about 10 Gbps. The eMBB makes it possible to far surpass basic mobile Internet access, and covers full-duplex operations, media in cloud or augmented reality, and entertainment applications. Data is one of the key drivers of 5G, and it may not be possible to see dedicated voice services for the first time in the 5G era. In 5G, voice is expected to be processed as an application program simply using data connection provided by a communication system. A main reason for an increased traffic volume is an increase in content size and an increase in the number of applications requiring high data rates. Streaming services (audio and video), interactive video and mobile Internet connections will become more prevalent as more devices are connected to the Internet. Many of these applications require always-on connectivity to push real-time information and notifications to users. Cloud storage and applications are rapidly increasing in mobile communication platforms, which may be applied to both work and entertainment. Cloud storage is a special use case that drives the growth of uplink data rates. 5G is also used for remote work in the cloud and requires much lower end-to-end latency to maintain a good user experience when tactile interfaces are used. In entertainment, for example, cloud gaming and video streaming are another key factor requiring improvement in mobile broadband capabilities. Entertainment is essential on smartphones and tablets anywhere, including in highly mobile environments such as trains, cars and airplanes. Another use case is augmented reality and information retrieval for entertainment. Here, augmented reality requires very low latency and an instantaneous data amount.

The mMTC, which is designed to enable communication between a large number of low-cost devices powered by batteries, is provided to support smart metering, logistics, fields, and applications such as body sensors. The mMTC aims at about 10-year batteries and/or about one million devices per km². The mMTC enables seamless connection of embedded sensors in all fields to form a sensor network and is one of the most anticipated 5G use cases. Potentially, IoT devices are predicted to reach 20.4 billion by 2020. Smart networks utilizing industrial IoT is one of the areas where 5G plays a key role in enabling smart cities, asset tracking, smart utilities, agriculture and security infrastructure.

The URLLC, which enables devices and machines to communicate with high reliability, very low latency, and high availability, are ideal for vehicle communications, industrial control, factory automation, telesurgery, smart grid, and public safety applications. The URLLC aims at a delay of about 1 ms. The URLLC includes new services that will change the industry through ultra-reliable/low-latency links such as remote control of key infrastructures and autonomous vehicles. Levels of reliability and latency are essential for smart grid control, industrial automation, robotics, and drone control and adjustment.

Next, a plurality of usage examples included in the triangle of FIG. 19 will be described in more detail.

5G, which is a means of providing streams that are rated as hundreds of megabits per second to a gigabit per second, may complement fiber-to-the-home (FTTH) and cable-based broadband (or data over cable service interface specifications (DOCSIS)). Such a high speed may be required to deliver TVs with resolution of 4K or higher (6K, 8K and higher) as well as virtual reality (VR) and augmented reality (AR). VR and AR applications involve almost immersive sports events. Specific applications may require special network configuration. For example, in the case of VR games, a game company may need to integrate a core server with an edge network server of a network operator to minimize latency.

Automotive is expected to be an important new driver for 5G together with many use cases for mobile communication regarding vehicles. For example, entertainment for passengers require both high capacity and high mobile broadband. The reason is because future users will continue to expect high-quality connections, regardless of their location and speed. Another use case in the automotive sector is an augmented reality dashboard. The augmented reality dashboard allows drivers to identify objects in the dark on top of what they see through a front window. The augmented reality dashboard superimposes information to be provided to the driver regarding a distance and movement of objects. In the future, wireless modules will enable communication between vehicles, exchange of information between a vehicle and a supporting infrastructure, and exchange of information between a vehicle and other connected devices (e.g., devices carried by pedestrians). A safety system may lower the risk of accidents by guiding the driver to alternative courses of action to make driving safer. A next step will be a remotely controlled vehicle or an autonomous vehicle. This requires very reliable and very fast communication between different autonomous vehicles and/or between vehicles and infrastructure. In the future, autonomous vehicles will perform all driving activities and drivers will be forced to focus only on traffic anomalies that the vehicle itself cannot identify. The technical requirements of autonomous vehicles require ultra-low latency and ultra-fast reliability to increase traffic safety to levels that cannot be achieved by humans.

Smart cities and smart homes referred to as smart society will be embedded with high-density wireless sensor networks as an example of smart networks. A distributed network of intelligent sensors will identify the conditions for cost and energy efficient maintenance of a city or home. A similar setup may be done for each household. Temperature sensors, window and heating controllers, burglar alarms, and home appliances are all wirelessly connected. Many of these sensors typically require low data rates, low power, and low cost. However, for example, real-time HD video may be required in certain types of devices for surveillance.

The consumption and distribution of energy including heat or gas is highly decentralized, requiring automated control of distributed sensor networks. A smart grid interconnects these sensors using digital information and communication technologies to collect information and act accordingly. This information may include the behavior of suppliers and consumers, so that the smart grid may improve efficiency, reliability, economical efficiency, sustainability of production, and a distribution of fuels such as electricity in an automated manner. The smart grid may also be considered as another low-latency sensor network.

A health sector has many applications that may benefit from mobile communications. The communication system may support telemedicine providing clinical care from remote locations. This may help reduce barriers to distance and improve access to medical services that are not consistently available in remote rural areas. It is also used to save lives in critical care and emergencies. A wireless sensor network based on mobile communication may provide remote monitoring and sensors for parameters such as a heart rate and blood pressure.

Wireless and mobile communications are becoming increasingly important in industrial applications. Wiring is expensive to install and maintain. Thus, a possibility of replacing cables with reconfigurable wireless links is an attractive opportunity for many industries. However, achieving this requires that a wireless connection operates with a delay, reliability and capacity similar to those of a cable and requires simplified management. Low latency and very low error probability are new requirements that need to be connected to 5G.

Logistics and cargo tracking is an important use case for mobile communications that enables tracking of inventory and packages from anywhere using a location-based information system. Logistics and freight tracking use cases typically require low data rates but require a wide range and reliable location information.

<Artificial Intelligence (AI)>

Artificial intelligence refers to a field of studying artificial intelligence or a methodology for creating the same, and machine learning refers to a field of defining various problems dealing in an artificial intelligence field and studying methodologies for solving the same. The machine learning may be defined as an algorithm for improving performance with respect to a certain task through repeated experiences with respect to the task.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value

<Robot>

A robot may refer to a machine which automatically handles a given task by its own ability, or which operates autonomously. Particularly, a robot that functions to recognize an environment and perform an operation according to its own judgment may be referred to as an intelligent robot.

Robots may be classified into, for example, industrial, medical, household, and military robots, according to the purpose or field of use.

A robot may include an actuator or a driving unit including a motor in order to perform various physical operations, such as moving joints of the robot. In addition, a movable robot may include, for example, a wheel, a brake, and a propeller in the driving unit thereof, and through the driving unit, may thus be capable of traveling on the ground or flying in the air.

<Self-Driving or Autonomous-Driving>

Autonomous driving refers to self-driving technology, and an autonomous vehicle refers to a vehicle that moves without any manipulation by a user or with minimum manipulation by a user.

For example, autonomous driving may include all of a technology for keeping a vehicle within a driving lane, a technology for automatically controlling a speed such as an adaptive cruise control, a technology for automatically driving the vehicle along a determined route, and a technology for, when a destination is set, automatically setting a route and driving the vehicle along the route.

A vehicle includes a vehicle having only an internal combustion engine, a hybrid vehicle having both an internal combustion engine and an electric motor, and an electric vehicle having only an electric motor, and may include not only an automobile but also a train, a motorcycle, or the like.

In this case, an autonomous vehicle may be considered as a robot with an autonomous driving function.

<Extended Reality; XR>

Extended reality collectively refers to virtual reality (VR), augmented reality (AR), and mixed reality (MR). The VR technology provides real world objects or backgrounds only in CG images, the AR technology provides virtual CG images together with real object images, and the MR technology is computer graphic technology for mixing and combining virtual objects with the real world.

The MR technology is similar to the AR technology in that both real and virtual objects are shown together. However, there is a difference in that a virtual object is used to complement a real object in the AR technology, whereas a virtual object and a real object are used in an equivalent nature in the MR technology.

The XR technology may be applied to a head-mount display (HMD), a head-up display (HUD), a mobile phone, a tablet PC, a laptop, a desktop, a TV, digital signage, etc. A device to which the XR technology is applied may be referred to as an XR device.

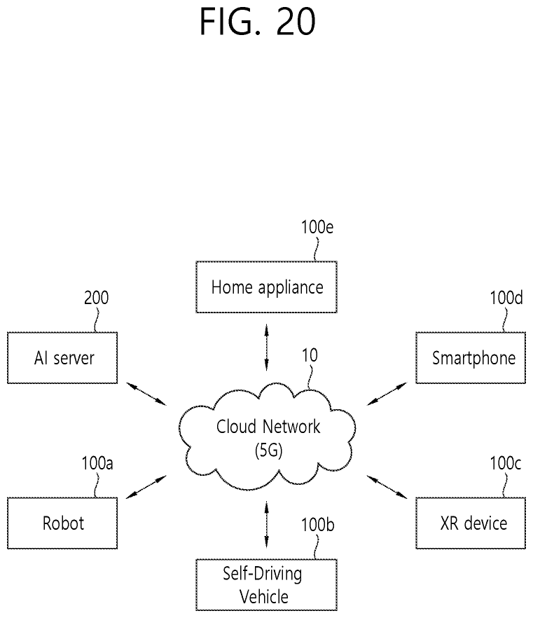

FIG. 20 shows an AI system 1 according to an embodiment.

Referring to FIG. 20, an AI system 1 is connected to at least one of an AI server 200, a robot 100a, a self-driving vehicle 100b, an XR device 100c, a smartphone 100d, or home appliances 100e over a cloud network 10. In this case, the robot 100a, the self-driving vehicle 100b, the XR device 100c, the smartphone 100d or the home appliances 100e to which the AI technology has been applied may be called AI devices 100a to 100e.

The cloud network 10 may be a network that constitutes a part of a cloud computing infrastructure or a network that exists in the cloud computing infrastructure. Here, the cloud network 10 may be configured using a 3G network, a 4G or long term evolution (LTE) network, or a 5G network.

The devices 100a to 100e and 200 configuring the AI system 1 may be interconnected over the cloud network. Particularly, the devices 100a to 100e and 200 may communicate with each other through a base station but may directly communicate with each other without the intervention of a base station.

The AI server 200 may include a server that performs AI processing and a server that performs an operation on big data.

The AI server 200 is connected to at least one of the robot 100a, the self-driving vehicle 100b, the XR device 100c, the smartphone 100d or the home appliances 100e, that is, AI devices configuring the AI system, over the cloud network 10 and may help at least some of the AI processing of the connected AI devices 100a to 100e.

In this case, the AI server 200 may train an artificial neural network based on a machine learning algorithm in place of the AI devices 100a to 100e, may directly store a learning model or may transmit the learning model to the AI devices 100a to 100e.

In this case, the AI server 200 may receive input data from the AI devices 100a to 100e, may deduce a result value of the received input data using the learning model, may generate a response or control command based on the deduced result value, and may transmit the response or control command to the AI devices 100a to 100e.

Alternatively, the AI devices 100a to 100e may directly deduce a result value of input data using a learning model and may generate a response or control command based on the deduced result value.

Hereinafter, various embodiments of the AI devices 100a to 100e to which the aforementioned technology is applied will be described.

<AI+Robot>

The robot 100a, which adopts an AI technology, may be implemented as a guide robot, a transport robot, a cleaning robot, a wearable robot, an entertainment robot, a pet robot, an unmanned flying robot, and the like.

The robot 100a may include a robot control module for controlling an operation, and the robot control module may refer to a software module or a chip implemented with hardware.

The robot 100a may acquire status information of the robot 100a using sensor information acquired from various types of sensors, detect (recognize) surrounding environments and objects, generate map data, determine moving routes and driving plans, determine responses to user interactions, or determine actions.

Here, the robot 100a may use sensor information obtained from at least one sensor from among lidar, radar, and camera to determine a moving route and a driving plan.

The robot 100a may perform the above operations using a learning model including at least one artificial neural network. For example, the robot 100a may recognize a surrounding environment and an object using a learning model and may determine an operation using the recognized surrounding environment information or object information. Here, the learning model may be directly learned by the robot 100a or learned by an external device such as the AI server 200.

Here, the robot 100a may directly generate a result using a learning model and perform an operation, or transmit sensor information to an external device such as the AI server 200, receive a result generated accordingly, and perform an operation.

The robot 100a may determine a moving path and a driving plan using at least one of map data, object information detected from sensor information, or object information acquired from an external device, and control a driving unit to drive the robot 100a according to the moving path and the driving plan.

The map data may include object identification information on various objects arranged in a space in which the robot 100a moves. For example, the map data may include object identification information on fixed objects such as walls and doors and movable objects such as flower pots and desks. In addition, the object identification information may include a name, a type, a distance, and a location.

In addition, the robot 100a may perform an operation or run by controlling the driving unit based on the user's control/interaction. In this case, the robot 100a may acquire interaction intention information according to a user's motion or voice speech, determine a response based on the acquired intention information, and perform an operation.

<Combination of AI, Robot, Autonomous Driving, and XR>

The autonomous vehicle 100b may be implemented as a mobile robot, vehicle, or unmanned aerial vehicle by applying AI technology.

The XR device 100c may be implemented as a head-mounted display (HMD), a head-up display (HUD) provided in a vehicle, a TV, a mobile phone, a smartphone, a computer, a wearable device, a home appliance, a digital signage, a vehicle, a fixed robot or a moving robot, etc, by applying the AI technology,

The robot 100a may be implemented as a guide robot, a transport robot, a cleaning robot, a wearable robot, an entertainment robot, a pet robot, an unmanned flying robot, etc., by applying the AI technology and an autonomous driving technology.

The robot 100a may be implemented as a guide robot, a transport robot, a cleaning robot, a wearable robot, an entertainment robot, a pet robot, an unmanned flying robot, a drone, etc., by applying the AI technology and an XR technology.

The autonomous vehicle 100b may be implemented as a mobile robot, a vehicle, or an unmanned vehicle by applying the AI technology and the XR technology.

In the above exemplary systems, although the methods have been described on the basis of the flowcharts using a series of the steps or blocks, the present disclosure is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present disclosure.

The claims set forth herein may be combined in various ways. For example, the technical features of the method claims of the present disclosure may be combined to be implemented as a device, and the technical features of the device claims of the present disclosure may be combined to be implemented as a method. In addition, the technical features of the method claims of the present disclosure and the technical features of the device claims may be combined to be implemented as a device, and the technical features of the method claims of the present disclosure and the technical features of the device claims may be combined to be implemented as a method.

What is claimed is:

1. A method for transmitting a paging message to a communication device, the method performed by a first network node and the method comprising:
receiving a second message related to downlink data to be transmitted to the communication device from a second network node;
transmitting a paging message and a non-access stratum (NAS) notification message to the communication device when the second message is related to a first service and the communication device is in Idle state for 3^{rd} generation partnership project (3GPP) access,
wherein the paging message is transmitted to the communication device through the 3GPP access and the NAS notification is transmitted to the communication device through non-3GPP access; and
receiving a service request message for the downlink data from the communication device through the 3GPP access.

2. The method of claim 1,
wherein the communication device is in an Idle state for the 3GPP access and the communication device is in a connected state for the non-3GPP access.

3. The method of claim 1, further comprising:
determining whether the second message is related to the first service.

4. The method of claim 3,
wherein the second message includes an allocation and retention priority (ARP) value, and
wherein whether the second message is related to the first service is determined based on the ARP value included in the second message.

5. The method of claim 3,
wherein the second message further includes first information informing that the second message is related to the first service, and
wherein whether the second message is related to the first service is determined based on the first information included in the second message.

6. The method of claim 3,
wherein whether the second message is related to the first service is determined based on second information stored in the first network node.

7. The method of claim 6,
wherein the second information includes at least one of a PDU session ID related to the first service, a data network name (DNN) related to the first service, single-network slice selection assistance information (S-NSSAI) related to the first service, or UE capability information related to the first service.

8. The method of claim 6,
wherein the second message includes a PDU session ID related to the downlink data, and
wherein whether the second message is related to the first service is determined based on the PDU session ID included in the second message and the second information.

9. The method of claim 1,
wherein the first network node is an access and mobility management function (AMF), and the second network node is a session management function (SMF).

10. A method for transmitting a service request message, the method performed by a communication device and comprising:
receiving a first message including information indicating that establishment of a PDU session associated with a first service is accepted from a second network node;
receiving at least one of a paging message for downlink data or a non-access stratum (NAS) notification message related to the downlink data,
wherein the downlink data is associated with the first service, and
wherein the paging message is transmitted to the communication device through 3^{rd} generation partnership project (3GPP) access, and the NAS notification message is transmitted to the communication device through non-3GPP access; and
transmitting a service request message for the downlink data,
wherein the communication device is in an Idle state for the 3GPP access and the communication device in a connected state for the non-3GPP access.

11. The method of claim 10,
wherein the service request message is transmitted through the 3GPP access.

12. The method of claim 11, further comprising:
handing over the PDU session associated with the first service from the 3GPP access to the non-3GPP access when transmission of the service request message through the 3GPP access fails.

13. The method of claim 10,
wherein the communication device is an autonomous driving device that communicates with at least one of a mobile terminal, a network, and an autonomous vehicle other than the communication device.

14. A processor of a first network, the processor controlling the first network node,
wherein the processor is configured to:
receive a second message related to downlink data to be transmitted from the second network node to the communication device,
transmit a paging message and a non-access stratum (NAS) notification message to the communication device when the second message is related to a first service and the communication device is Idle state for 3^{rd} generation partnership project (3GPP) access,
wherein the paging message is transmitted to the communication device through the 3GPP access and the NAS notification is transmitted to the communication device through non-3GPP access; and
receive a service request message for the downlink data from the communication device through the 3GPP access.
